(19) United States
(12) Patent Application Publication
(10) Pub. No.: US 2009/0078757 A1
(43) Pub. Date: Mar. 26, 2009

(54) Information management system and method

(76) Inventors: Bradley C. Hanson, Harrisburg, SD (US); Christopher E. Murfin, Sioux Falls, SD (US); Staci L. Unruh, Sioux Falls, SD (US); Jeana M. Squier, Monroe, SD (US); Michael J. Conlin, Minneapolis, MN (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 10/590,439

(22) PCT Filed: Mar. 24, 2006
(86) PCT No.: PCT/US2006/011148

§ 371 Date: Dec. 1, 2008

(51) Int. Cl. G06Q 30/00

(52) U.S. Cl. 235/380

(57) ABSTRACT

An information management system includes a computer server. The computer server includes an interface module. The information management system also includes a plurality of card processors in communication with the computer server via the interface module. The computer server is configured to interface with each of the plurality of card processors via the interface module. The computer server is configured to choose one of the plurality of card processors in accordance with a unique identifier associated with a card product to process information associated with the card product.

### CROSS-REFERENCE TO RELATED APPLICATION

This application is a U.S. National Phase patent application that claims the benefit under 35 U.S.C. § 365 of International Application No. PCT/US2006/011148, filed Mar. 24, 2006, the entire contents of which are hereby incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

1. Field of the Invention

The present invention relates to computer-based information management systems. More particularly, the present invention relates to a system and method for managing information associated with card products.

2. Background Information

Increasing numbers of retail and other institutions are now offering cash-equivalent value in the form of gift cards. The gift card industry has experienced substantial growth over the past few years. Total gift card sales reached approximately $20 billion in 2004. The range of gift cards offered by institutions has become expansive, including cards from retailers, supermarkets, drug-stores, gas stations, restaurants, convenience stores, and hair salons, to name but a few.

Most gift cards are associated with a particular retailer or merchant. In other words, any value stored on the gift card can only be used to purchases goods and services at the particular retailer or merchant from whom the gift card was purchased, so that the merchant can gain the benefit of a guaranteed sale. Such proprietary gift cards can be referred to as “closed system” cards. Merchants can cover the cost of their gift card programs from the margin in their products, which can be, for example, $15 or more on a $50 sale.

However, a growing industry trend is for financial institutions to offer prepaid or “open system” branded gift cards. Open system cards are issued by a federally-regulated financial institution and carry a major network brand, such as, for example, MasterCard™, VISA™, Discover™ and the like, and including debit networks such as STAR™, Pulse™, NYCE™ and others. For example, the prepaid VISA™ gift card can be used at any retailer or merchant that accepts VISA™ debit cards, which includes millions of locations worldwide, as well as Internet and mail order/telephone order merchants. Such prepaid gift cards can be used for corporate incentives, rebates and promotions, and can be sold in branches of a financial institution, through the financial institution's consumer website, or distributed through corporate clients. The market for bank-issued gift cards is predicted to grow from $3 billion in 2003 to approximately $31 billion in 2007.

Open system branded gift cards differ from proprietary “store” gift cards in several aspects. For example, bank-issued gift cards can be used at any merchant. Except for a small amount of interchange, the bank or other financial institution does not benefit from the sale of the products/services purchased with the card or share in the profits of the sale. Rather, monthly administrative fees can be used to maintain the economic viability of the bank-issued gift card product.

Open system branded gift cards share many basic features. For example, these cards are guaranteed by the network and financial institution. Funds are maintained and controlled by the financial institution. Cards can be used anywhere the network brands are accepted. Cards can be replaced if lost, stolen or expired. In addition, consumers can gain protection from fraudulent activity.

However, conventional methods of purchasing such gift cards has been relatively complex. For example, consumers can wait for long periods of time at a point of sale while the clerk or sales agent processes the gift card purchase. Online gift card purchasing sites do little to alleviate the complexity of purchasing gift cards. For example, many online websites experience difficulty in assigning users, present multiple, complex screens through which users must navigate to purchase gift cards, and other like difficulties.

Additionally, because each of these gift cards is associated with a particular financial institution, consumers are forced to interact with many different entities to purchase and manage these gift cards. For example, if a consumer or other user possesses several gift cards, each issued by a different financial institution, the user must navigate to and access a different website for each gift card from each financial institution to sign up and administer each card separately.

Therefore, there is a need for a system that can reduce the complexity and streamline the process of managing and administering gift cards and other non-reloadable and reloadable card products across many financial institutions.

### SUMMARY OF THE INVENTION

A system for managing information associated with card products and a method for managing card product information across multiple card processors are disclosed. In accordance with exemplary embodiments of the present invention, according to a first aspect of the present invention, an information management system includes a computer server. The computer server includes an interface module. The information management system includes a plurality of card processors in communication with the computer server via the interface module. The computer server is configured to interface with each of the plurality of card processors via the interface module. The computer server is configured to choose one of the plurality of card processors in accordance with a unique identifier associated with a card product to process information associated with the card product.

According to the first aspect, the interface module can be configured to transform messages for communication to a respective card processor into a format utilized by the respective card processor. Messages to the card processors can include a query comprising a computer network address of a file. An encryption of the computer network address can be appended to an end of the query. The interface module can be configured to detect tampering with the computer network address by comparing the computer network address and a decryption of the encrypted computer network address. Alternatively, the interface module can be configured to detect tampering with the computer network address by comparing the encrypted computer network address and a re-encryption of the computer network address. The interface module can be configured to receive information associated with card products from each of the card processors. The information from each of the card processors can be normalized to transform the information into a uniform format utilized by the computer server. The transformed information can be validated to ensure accuracy of the information.

According to the first aspect, the information management system can include database in communication with the computer server. The database module can be configured to store information associated with card products. The information management system can include a management module in communication with the database. The management module can be configured to manage the information management system. The card processors can be configured to associate corresponding bank identification numbers (BINs) to the card products. The computer server can be configured to allocate card numbers corresponding to each BIN for the card products. The computer server can be configured to display a summary of card numbers for each BIN through the graphical user interface. Each card product can comprise a card number. The card number can comprise a first portion of digits and a second portion of digits. The first portion of digits can comprise a BIN. The card processors can be configured to associate BINs to the card products. The computer server can be configured to allocate card numbers to substantially all of the second portion of digits for each BIN.

According to a second aspect of the present invention, a card product management system includes an agent portal module. The card product management system includes a plurality of card processors in communication with the agent portal module. The agent portal module is configured to interface with each of the plurality of card processors. The agent portal module is configured to choose one of the plurality of card processors in accordance with a unique identifier associated with a card product to process information associated with the card product.

According to the second aspect, the agent portal module can be configured to manage information associated with card products for the plurality of card processors. The agent portal module can include a client application server module. The client application server module can be configured to transform messages for communication to a respective card processor into a format utilized by the respective card processor. Messages to the card processors can include a query comprising a computer network address of a file. An encryption of the computer network address can be appended to an end of the query. The client application server module can be configured to detect tampering with the computer network address by comparing the computer network address and a decryption of the encrypted computer network address. Alternatively, the client application server module can be configured to detect tampering with the computer network address by comparing the encrypted computer network address and a re-encryption of the computer network address. For example, the encryption of the computer network address can comprise a cryptographic hash function. The client application server module can be configured to receive information associated with card products from each of the card processors. The information from each of the card processors can be normalized to transform the information into a uniform format utilized by the agent portal module. The information from each card processor can comprise a plurality of reports. The plurality of reports can comprise at least one of a general report, a posted report and an authorization report. The transformed information can be validated to ensure accuracy of the information.

According to the second aspect, the client application server module can be configured to generate reports for information associated with card products. Each report can be populated with information in accordance with an identification of a user. The card product management system can comprises a database module in communication with the client application server module. The database module can be configured to store information associated with card products. The card product management system can include a management application server module in communication with the database module. The management application server module can be configured to manage the card product management system. The agent portal module can be configured to allow access by users to manage information associated with the card products. The agent portal module can include a graphical user interface module. The graphical user interface module can be configured to display a graphical user interface through which users interact with the card product management system.

According to the second aspect, a user can be granted access to the card product management system through the graphical user interface using a password and an associated computer network address of the user. Products can be presented to a user through the graphical user interface in accordance with at least one of a user identification and an association with a financial institution. A theme of the graphical user interface can be associated with each card processor. Each card processor can be presented with the theme associated with the card processor when interacting with the card product management system through the graphical user interface. The card processors can be configured to associate corresponding BINs to the card products. The agent portal module can be configured to allocate card numbers corresponding to each BIN for the card products. The agent portal module can be configured to display a summary of card numbers for each BIN through the graphical user interface.

According to the second aspect, the unique identifier can comprise a bank identification number (BIN). Each card product can comprise a card product number. The card product number can comprise a first portion of digits and a second portion of digits. The first portion of digits can comprise a BIN. The card processors can be configured to associate BINs to the card products. The agent portal module can be configured to allocate card numbers to substantially all of the second portion of digits for each BIN. The card product can comprise a gift card. The gift card can be issued by a financial institution. The card product can comprise a debit card. The card product can comprise a health savings account (HSA) card. The card product can comprise a flexible spending account (FSA) card. The card product can comprise a reloadable payroll card. At least one of the plurality of card processors can comprise a bank or the like.

According to a third aspect of the present invention, a system for processing card products includes a plurality of card products. Each card product comprises a card product number. The card product number comprises a first portion of digits and a second portion of digits. The first portion of digits comprises a bank identification number (BIN). Each BIN is assigned to a card processor. The system includes a non-processor. The non-processor is configured to manage information associated with the plurality of card products. The non-processor is configured to assign values to substantially all of the second portion of digits of each card product.

According to the third aspect, the values assigned to substantially all of the second portion of digits of each card product can comprise a card number. The non-processor can be configured to allocate card numbers for each BIN. Card numbers can be allocated sequentially for each BIN. Alternatively, card numbers can be allocated randomly for each BIN. The values assigned to substantially all of the second portion of digits of each card product can correspond to separate users.

According to a fourth aspect of the present invention, a method of managing card product information includes the steps of: a.) interfacing with each of a plurality of card processors; and b.) selecting one of the plurality of card processors in accordance with a unique identifier associated with a card product to process information associated with the card product.

According to the fourth aspect, the method can include the steps of: c.) managing information associated with card products for the plurality of card processors; and d.) transforming messages for communication to a respective card processor into a format utilized by the respective card processor. Messages to the card processors can include a query comprising a computer network address of a file. The method can include the steps of: e.) encrypting the computer network address; f.) appending the encrypted computer network address to an end of the query; and g.) detecting tampering with the computer network address by comparing the computer network address and a decryption of the encrypted computer network address. Alternatively, step (g) can comprise the step of: g.) detecting tampering with the computer network address by comparing the encrypted computer network address and a re-encryption of the computer network address. For example, according to an exemplary embodiment of the fourth aspect, step (e) can be performed using a cryptographic hash function. The method can include the steps of: h.) receiving information associated with card products from each of the card processors; and i.) normalizing the information from each of the card processors to transform the information into a uniform format. The information from each card processor can comprise a plurality of reports. The plurality of reports can comprise at least one of a general report, a posted report and an authorization report.

According to the fourth aspect, the method can include the steps of: j.) validating the transformed information to ensure accuracy of the information; k.) generating reports for information associated with the card product; l.) populating each report with information in accordance with an identification of a user; m.) storing information associated with card products; and n.) providing access to users to manage information associated with card products; o.) displaying a graphical user interface through which users access information associated with card products; p.) granting access to a user through the graphical user interface using a password and an associated computer network address of the user; and q.) presenting products to a user through the graphical user interface in accordance with at least one of a user identification and an association with a financial institution. A theme of the graphical user interface can be associated with each card processor. The method can include the step of: r.) presenting each card processor with the theme associated with the card processor when interacting through the graphical user interface. The card processors can be configured to associate corresponding bank identification numbers (BINs) to the card products. The method can include the step of: s.) allocating card numbers corresponding to each BIN for the card products. According to the fourth aspect, the method can include the step of: t.) displaying a summary of card numbers for each BIN.

According to the fourth aspect, the unique identifier can comprise a bank identification number (BIN). Each card product can comprise a card product number. The card product number can comprise a first portion of digits and a second portion of digits. The first portion of digits can comprise a BIN. The card processors can be configured to associate BINs to the card products. The method can include the step of: v.) allocating card numbers to substantially all of the second portion of digits for each BIN. The card product can comprise a gift card. The gift card can be issued by a financial institution. The card product can comprise a debit card. The card product can comprise a health savings account (HSA) card. The card product can comprise a flexible spending account (FSA) card. The card product can comprise a reloadable payroll card. At least one of the plurality of card processors comprises a bank.

According to a fifth aspect of the present invention, a method of processing card products includes the steps of: a.) associating a bank identification number (BIN) to each of a plurality of card products by a card processor, wherein each card product comprises a card product number, wherein the card product number comprises a first portion of digits and a second portion of digits, and wherein the first portion of digits comprises the BIN; and b.) assigning values to substantially all of the second portion of digits of each card product by a non-processor, wherein the non-processor is configured to manage information associated with the plurality of card products.

According to the fifth aspect, the values assigned to substantially all of the second portion of digits of each card product can comprise a card number. The method can include the step of: c.) allocating card numbers for each BIN by the non-processor. Step (c) can comprise the step of: d.) sequentially allocating card numbers for each BIN. Alternatively, step (c) can comprise the step of: e.) randomly allocating card numbers for each BIN. The values assigned to substantially all of the second portion of digits of each card product can correspond to separate users.

According to a sixth aspect of the present invention, a system for managing card product information includes means for interfacing with each of a plurality of card processors. The system includes means for selecting one of the plurality of card processors in accordance with a unique identifier associated with a card product to process information associated with the card product.

According to the sixth aspect, the system can include means for managing information associated with card products for the plurality of card processors. The system can include means for transforming messages for communication to a respective card processor into a format utilized by the respective card processor. Messages to the card processors include a query comprising a computer network address of a file. The system can include means for encrypting the computer network address. The system can include means for appending the encrypted computer network address to an end of the query. The system can include means for detecting tampering with the computer network address by comparing the computer network address and a decryption of the encrypted computer network address. Alternatively, the system can include means for detecting tampering with the computer network address by comparing the encrypted computer network address and a re-encryption of the computer network address. For example, the encrypting means can use a cryptographic hash function to encrypt the computer network address.

According to the sixth aspect, the system can include means for receiving information associated with card products from each of the card processors. The system can include means for normalizing the information from each of the card processors to transform the information into a uniform format. The information from each card processor can comprise a plurality of reports. The plurality of reports can comprise at least one of a general report, a posted report and an authorization report. The system can include means for validating the transformed information to ensure accuracy of the information. The system can include means for generating reports for information associated with the card product. The system can include means for populating each report with information in accordance with an identification of a user. The system can include means for storing information associated with card products. The system can include means for providing access to users to manage information associated with card products. The system can include means for displaying a graphical user interface through which users access information associated with card products.

According to the sixth aspect, the system can include means for granting access to a user through the graphical user interface using a password and an associated computer network address of the user. The system can include means for presenting products to a user through the graphical user interface in accordance with at least one of a user identification and an association with a financial institution. A theme of the graphical user interface is associated with each card processor. The system can include means for presenting each card processor with the theme associated with the card processor when interacting through the graphical user interface. The card processors can be configured to associate corresponding bank identification numbers (BINs) to the card products. The system can include means for allocating card numbers corresponding to each BIN for the card products. The system can include means for displaying a summary of card numbers for each BIN.

According to the sixth aspect, the unique identifier can comprise a bank identification number (BIN). Each card product can comprise a card product number. The card product number can comprise a first portion of digits and a second portion of digits. The first portion of digits can comprise a BIN. The card processors can be configured to associate BINs to the card products. The system can include means for allocating card numbers to substantially all of the second portion of digits for each BIN. The card product can comprise a gift card. The gift card can be issued by a financial institution. The card product can comprise a debit card. The card product can comprise a health savings account (HSA) card. The card product can comprise a flexible spending account (FSA) card. The card product can comprise a reloadable payroll card. At least one of the plurality of card processors comprises a bank.

According to a seventh aspect of the present invention, a system for processing card products includes means for associating a bank identification number (BIN) to each of a plurality of card products by a card processor. Each card product comprises a card product number. The card product number comprises a first portion of digits and a second portion of digits. The first portion of digits comprises the BIN. The system includes means for assigning values to substantially all of the second portion of digits of each card product by a non-processor. The non-processor is configured to manage information associated with the plurality of card products.

According to the seventh aspect, the values assigned to substantially all of the second portion of digits of each card product can comprise a card number. The system can include means for allocating card numbers for each BIN by the non-processor. The system can include means for sequentially allocating card numbers for each BIN. Alternatively, the system can include means for randomly allocating card numbers for each BIN. The values assigned to substantially all of the second portion of digits of each card product can correspond to separate users.

According to a eighth aspect of the present invention, a computer-readable medium contains a computer program for managing card product information. The computer program performs the steps of: a.) interfacing with each of a plurality of card processors; and b.) selecting one of the plurality of card processors in accordance with a unique identifier associated with a card product to process information associated with the card product.

According to the eighth aspect, the computer program can perform the steps of: c.) managing information associated with card products for the plurality of card processors; and d.) transforming messages for communication to a respective card processor into a format utilized by the respective card processor. Messages to the card processors can include a query comprising a computer network address of a file. The computer program can perform the steps of: e.) encrypting the computer network address; f.) appending the encrypted computer network address to an end of the query; and g.) detecting tampering with the computer network address by comparing the computer network address and a decryption of the encrypted computer network address. Alternatively, for step (g), the computer program can perform the step of: g.) detecting tampering with the computer network address by comparing the encrypted computer network address and a re-encryption of the computer network address. For example, step (e) can be performed by the computer program using a cryptographic hash function. The computer program can perform the steps of: h.) receiving information associated with card products from each of the card processors; and i.) normalizing the information from each of the card processors to transform the information into a uniform format. The information from each card processor can comprise a plurality of reports. The plurality of reports can comprise at least one of a general report, a posted report and an authorization report.

According to the eighth aspect, the computer program can perform the steps of: j.) validating the transformed information to ensure accuracy of the information; k.) generating reports for information associated with the card product; l.) populating each report with information in accordance with an identification of a user; m.) storing information associated with card products; n.) providing access to users to manage information associated with card products; o.) generating a graphical user interface through which users access information associated with card products; p.) granting access to a user through the graphical user interface using a password and an associated computer network address of the user; and q.) generating a presentation of products to a user through the graphical user interface in accordance with at least one of a user identification and an association with a financial institution. A theme of the graphical user interface can be associated with each card processor. The computer program can perform the step of: r.) generating the theme associated with the card processor to each card processor when interacting through the graphical user interface. The card processors can be configured to associate corresponding bank identification numbers (BINs) to the card products. The computer program can perform the steps of: s.) allocating card numbers corresponding to each BIN for the card products; and t.) generating a summary of card numbers for each BIN.

According to the eighth aspect, the unique identifier can comprise a bank identification number (BIN). Each card product can comprise a card product number. The card product number can comprise a first portion of digits and a second portion of digits. The first portion of digits can comprise a BIN. The card processors can be configured to associate BINs to the card products. The computer program can perform the step of: v.) allocating card numbers to substantially all of the second portion of digits for each BIN. The card product can comprise a gift card. The gift card can be issued by a financial institution. The card product can comprise a debit card. The card product can comprise a health savings account (HSA) card. The card product can comprise a flexible spending account (FSA) card. The card product can comprise a reloadable payroll card. At least one of the plurality of card processors comprises a bank.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a card product management system, in accordance with an exemplary embodiment of the present invention.

FIG. 2 is report specification for a general or non-financial report, in accordance with an exemplary embodiment of the present invention.

FIG. 3 is report specification for a posted report, in accordance with an exemplary embodiment of the present invention.

FIG. 4 is report specification for an authorization report, in accordance with an exemplary embodiment of the present invention.

FIG. 5 is an example of a graphical user interface for viewing orders through the card product management system, in accordance with an exemplary embodiment of the present invention.

FIG. 6 is a diagram illustrating a transaction flow for a gift card issued by a card processor, in accordance with an exemplary embodiment of the present invention.

FIG. 7 is an illustration of an overview page for the management application server module, in accordance with an exemplary embodiment of the present invention.

FIGS. 8A, 8B and 8C illustrate a processors page, a clients page and a programs page, respectively, in accordance with an exemplary embodiment of the present invention.

FIG. 9 illustrates a client detail page, in accordance with an exemplary embodiment of the present invention.

FIG. 10 illustrates a program details page, in accordance with an exemplary embodiment of the present invention.

FIG. 11 illustrates a clients contracts page, in accordance with an exemplary embodiment of the present invention.

FIG. 12 illustrates a client quality page, in accordance with an exemplary embodiment of the present invention.

FIG. 13 illustrates a program project plans page, in accordance with an exemplary embodiment of the present invention.

FIG. 14 illustrates a program finding page, in accordance with an exemplary embodiment of the present invention.

FIG. 15 illustrates a program attributes page, in accordance with an exemplary embodiment of the present invention.

FIG. 16 illustrates a gift card report page, in accordance with an exemplary embodiment of the present invention.

FIG. 17 illustrates a work queue report page, in accordance with an exemplary embodiment of the present invention.

FIG. 18 illustrates a commission payable summary report page, in accordance with an exemplary embodiment of the present invention.

FIG. 19 illustrates a report files page, in accordance with an exemplary embodiment of the present invention.

FIG. 20 illustrates a financial report page, in accordance with an exemplary embodiment of the present invention.

FIG. 21 illustrates an account reconciliation report page, in accordance with an exemplary embodiment of the present invention.

FIG. 22 illustrates a statement generated by the card product management system, in accordance with an exemplary embodiment of the present invention.

FIG. 23 illustrates a statement definition report page, in accordance with an exemplary embodiment of the present invention.

FIG. 24 illustrates an exception report page, in accordance with an exemplary embodiment of the present invention.

FIGS. 25A and 25B illustrate exception detail report pages, in accordance with an exemplary embodiment of the present invention.

FIG. 26 illustrates a financial reports page, in accordance with an exemplary embodiment of the present invention.

FIGS. 27A and 27B illustrate financial report pages, in accordance with an exemplary embodiment of the present invention.

FIG. 28 illustrates a card number summary page, in accordance with an exemplary embodiment of the present invention.

FIG. 29 is a flowchart illustrating steps for managing card product information, in accordance with an exemplary embodiment of the present invention.

FIG. 30 is a flowchart illustrating steps for detecting tampering with information communicated to a card processor, in accordance with an exemplary embodiment of the present invention.

FIG. 31 is a flowchart illustrating steps for processing card products, in accordance with an exemplary embodiment of the present invention.

### DETAILED DESCRIPTION OF THE PREFERRED EMBODIMENTS

Exemplary embodiments of the present invention are directed to a system for managing information associated with card products and a method for managing card product information across multiple card processors. According to exemplary embodiments, a single bank agent portal provides an interface to multiple card processors to support administration and management of cards or other card products issued by different entities, such as, for example, financial institutions (e.g., banks) and the like. The bank agent portal can then choose one of the card processors to process information associated with the card products using unique identifying information associated with each card product. The card products can include, for example, gift cards (e.g., bank-issued gift cards), debit cards, and other non-reloadable card products, as well as reloadable card products, such as, for example, health savings account (HSA) cards, flexible spending account (FSA) cards, reloadable payroll cards and the like. By providing a single interface to multiple card processors, a user can effectively and easily manage any or all of these card products and other types of like financial transactions from a single site, regardless of the entity that issued the card.

According to exemplary embodiments, the bank agent portal provides a layer of abstraction between the user and the card processors. In other words, the present invention handles any and all inconsistencies and differences in interfaces, communications, data formats and the like between the various card processors, so that the user need only interact with a single, unified interface. Thus, the user can purchase, manage, and conduct administrative functions for any number of card products from any number of financial institutions without the need to separately conduct business with each institution (e.g., through each financial institution's website). For example, the user can generate and view summary reports of financial information associated with the card products issued from the different financial institutions.

According to an additional exemplary embodiment of the present invention, the card product management system can be used to allocate card numbers to card products issued by the financial institutions. Each card product includes a card product number that uniquely identifies the card, for example, a sixteen digit number or the like. For example, the first six digits of the card product number can be a bank identification number (BIN) assigned by the financial institution to a card processor. For the illustration of bank-issued gift cards, the remaining (e.g., ten) digits are conventionally used for assigning a BIN extension (e.g., six digits), a card number (e.g., three digits), and a check bit (e.g., one digit). The values of these remaining digits are also conventionally assigned by the financial institution. However, according to the additional exemplary embodiment, the card product management system can assign card numbers for the card products by using the entirety of the remaining digits (e.g., all ten remaining digits) to allocate card numbers for a particular BIN. An authorized user can then view, for example, a distribution summary of available card numbers for each BIN.

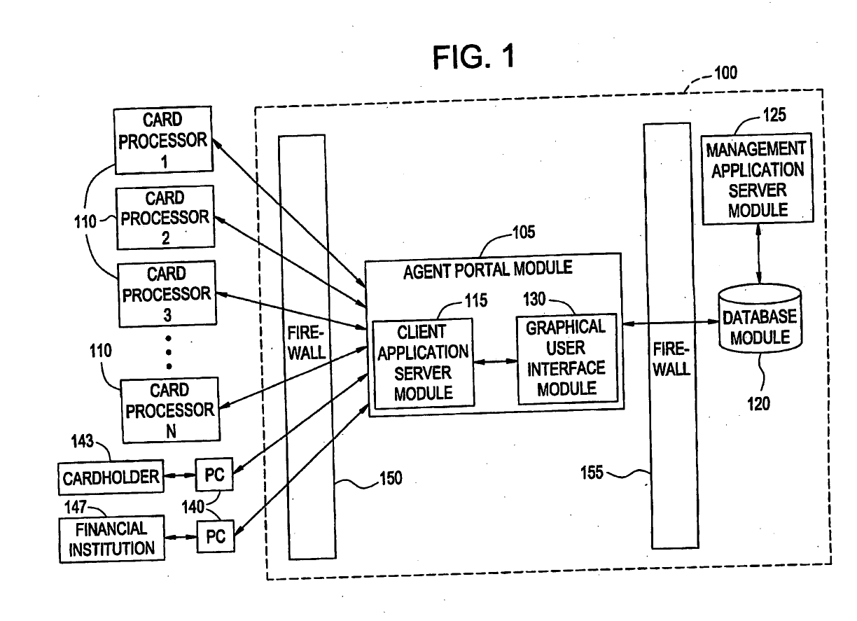

These and other aspects of the present invention will now be described in greater detail. FIG. 1 is a diagram illustrating a card product management system 100, in accordance with an exemplary embodiment of the present invention. The card product management system 100 (also referred to herein as simply the “system 100”) includes an agent portal module 105. A plurality of card processors 110 (card processor 1, card processor 2, card processor 3, . . . , card processor N, wherein N can be any suitable number) are in communication with the agent portal module 105. Each card processor 110 can communicate with the agent portal module 105 using any suitable form of communication medium and protocol, such as, for example, a local or remote network connection (e.g., via an intranet or the Internet or the like), a direct connection (e.g., a cable, such as a RS-232 connection), or any other suitable wired or wireless direct or networked connection.

According to exemplary embodiments, the agent portal module 105 is configured to interface with each of the card processors 110. Each card processor 110 can communicate with the agent portal module 105 in a manner that can be different than any or all of the other card processors 110. In other words, each card processor 110 can communicate with the agent portal module 105 using a different communication technology, protocol, protocol package, medium and the like. For purposes of illustration and not limitation, the first and third card processors 110 can use SOAP (the Simple Object Access Protocol) to communicate with the agent portal module 105, while the second and Nth card processors 110 can use XML-RPC to communicate with the agent portal module 105, although any suitable communication protocol can be used by the card processors 110. The agent portal module 105 is configured to encapsulate the interface to each card processor 110 so that the agent portal module 105 can communicate with each card processor 110 using the communication protocol used and understood by the respective card processor 110. Continuing with the present illustration, to communicate with the first and third card processors 110, the agent portal module 105 would use SOAP, while XML-RPC would be used to communicate with the second and Nth card processors 110. The agent portal module 105 can support any suitable communication protocol. As additional card processors 110 are placed in communication with the agent portal module 105, the communication parameters (protocol, message format and the like) for each new card processor 110 can be provided so that the agent portal module 105 can be configured to communicate with each new card processor 110 in the manner designated.

As used herein, a “card processor” is any suitable entity that services or processes card products. As used herein, a “card issuer” is any suitable entity that issues card products (e.g., an issuing bank or other like entity that is capable of issuing card products). For example, a card issuer assigns BINs to each card processor. As used herein, a “card product” can be any suitable type of non-reloadable or reloadable card or card-based product, such as, for example, a gift cards (e.g., a bank-issued gift cards), debit cards, health savings account (HSA) cards, flexible spending account (FSA) cards, reloadable payroll cards, travel cards, professional or collegiate team cards, savings account cards, credit cards or the like. For example, in the bank-issued gift card industry, a card processor 110 is simply referred to as a “processor” or “card processor.” A processor performs such functions as, for example, creating and maintaining cards and card product information, connecting with payment networks and sales agents to authorize card sales and purchase transactions, posting card transactions and fees to the appropriate card, providing card report data, and the like. Thus, as used herein, a “non-processor” refers to an entity other than a “processor” (i.e., other than an entity that processes or services card products). For example, the agent portal module 105 can be considered a “non-processor.” However, those of ordinary skill in the art will recognize that the card processor 110 can be any suitable entity that is capable of processing or servicing any suitable type of card product. According to exemplary embodiments, the card product management system 100 is configured to manage the information associated with the card products for the plurality of card processors 110.

The agent portal module 105 is configured to choose one of the plurality of card processors 110 in accordance with a unique identifier associated with a card product to process information associated with the card product. According to exemplary embodiments, each card product has a unique identifier that allows the card product management system 100 to associate a card product with the card processor 110 that generated that card product identifier. The unique identifier can be any suitable numeric or alpha-numeric string of characters, icon(s), symbol(s), image(s) or the like that is capable of uniquely identifying a card product and associating the card product with the card processor 110 that generated the card product identifier. For purposes of illustration and not limitation, assume that the card product is a bank-issued gift card. Such gift cards can include a sixteen digit numeric string, generally of the form: XXXX XXXX XXXX XXXX, where “X” can be any digit from 0 to 9, inclusive. The first six digits can comprise a bank identification number (BIN), i.e., a number that uniquely identifies the financial institution (e.g., bank) that services and/or processes the gift card, although any suitable number of digits can be used to specify the BIN. BINs can be assigned to each card processor 110 by card issuers, and the card processors 110 generally associate authorized BINs to the card products. The agent portal module 105 can then use the BIN associated with a card product to determine which of the plurality of card processors 110 with which to communicate information associated with the card product. Once the appropriate card processor 110 has been determined, the agent portal module 105 can then communicate with the card processor 110 using the method of communication and protocol native to the card processor 110. It is again noted that the present example is merely for purposes of illustration. Any suitable unique identifier can be used for each card product, as some card-based products may not use BINs.

Those of ordinary skill will recognize that the agent portal module 105 can be scaled to multiple agent portal modules 105 interconnected by suitable computer network communications to handle any suitable number of card processors 110.

The agent portal module 105 includes a client application server module 115. According to an exemplary embodiment, the client application server module 105 is configured to handle the communication and message passing with the card processors 110 on behalf of the agent portal module 105. The client application server module 105 is configured to choose the card processor 110 with which to communicate information associated with a card product based on the unique identifier of the card product. For example, the client application server module 115 can maintain or otherwise store a look-up table that maps the unique identifiers with the corresponding card processors 110. For purposes of illustration and not limitation, assuming that the card products are bank-issued gift cards or the like, then the look-up table can include a mapping of BINs to banks, such that information associated with a card product can be sent to the bank based on the BIN of the card product.

In addition, the client application server module 115 is configured to transform messages for communication to a respective card processor 110 into the message format utilized by the respective card processor 110. As discussed previously, any or all of the card processors 110 can use a different communication protocol for passing messages, data and other information. Once the client application server module 115 determines which of the card processors 110 to send the information, the client application server module 115 can then format the message in an appropriate manner (e.g., pre-pending a header and appending a checksum and the like to the body of the message) to conform to the protocol used by the selected card processor 110. For example, the client application server module 115 can maintain a look-up table that associates card processors 110 with communication protocols, so that for any particular card processor 110, the client application server module 115 can determine which communication protocol and other like parameters are supported by the selected card processor 110. Once appropriately formatted, the client application server module 115 can transmit the formatted message to the card processor 110. By managing the details of each communication link with each card processor 110, rather than having the card processors 110 conform to a communication protocol established by the card product management system 100, additional card processors 110 can be easily added or otherwise connected to the system 100 with little or no modification to the systems of the card processors 110. Alternatively, the card processor 110 can choose to communicate with the application server module 115 via a standard communication format and protocol established by the card product management system 100.

The client application server module 115 is also configured to receive information associated with card products from each of the card processors 110. However, any or all of the card processors 110 can send information (i.e., the data contained in the messages) in different data formats or a standard format provided by the card product management system 100. For example, numeric values of information can be specified using varying decimal places or none at all, codes or responses for a particular reply can be specified differently, and the like. Although the client application server module 115 can maintain separate data and data structures corresponding to each card processor 110, such processing tends to increase the complexity of the system 100.

According to an exemplary embodiment, the client application server module 115 is configured to normalize or otherwise map the information contained in each message from each of the card processors 115 to transform the information into a uniform format utilized by the card product management system 100. The client application server module 115 can use any suitable data format for all or substantially all processing within the system 100. For example, the client application server module 115 can maintain or otherwise store a suitable look-up or translation table to normalize or otherwise convert the information from the format supported by the card processor 110 to the format supported by the card product management system 100, and vice versa. For example, the client application server module 115 can transform data such as, for example, status codes, responses/replies, transaction details, or any other suitable information into the corresponding status codes, responses/replies, transaction details used by the client application server module 115.

For purposes of illustration and not limitation, assume that the client application server 115 receives a message from a particular card processor 110 that includes two fields. The client application server module 115 uses a uniform data format in which the first field is a gift card dollar amount, specified with two decimal places. The second field is an authorization field, specified as “ACCEPT” or “DENY.” However, the particular card processor 110 specifies the two fields differently—the first field is specified in whole numbers (i.e., no decimals), and the second fields is either “OK” or “NOT OK.” Thus, the two fields are populated by the card processor 110 with, for example, the value “5000” and the response “OK.” The client application server module 115 can determine the particular card processor 110 from which the message was received (e.g., by using the unique identifier associated with the card product to which the message pertains). The client application server module 115 can then perform a table look-up or translation to determine that, for this particular card processor 110, the value in the first field (i.e., “5000”) must be divided by 100 to obtain a value with two decimal points, and that the authorization response of “OK” corresponds to “ACCEPT.” Thus, by normalizing the data from each card processor 110 into a uniform data format, the client application server module 115 can manage any differences between data formats across the plurality of card processors 110. In addition, by managing the details of the data format supported by each card processor 110, rather than having the card processors 110 conform to the data format used by the card product management system 100, additional card processors 110 can be easily added or otherwise connected to the system 100 with little or no modification to the systems of the card processors 110.

Upon normalization into the format supported by the card product management system 100, the client application server module 115 is configured to validate or otherwise verify the normalized data to ensure the accuracy of that data. For example, since the client application server module 115 “understands” the format the data is to be in, the client application server module 115 can perform, for example, bounds or range checking on data, data verification, and other suitable checks on the normalized data. For example, continuing with the previous illustration, assume that the first field (i.e., the gift card dollar amount) is to be specified with two decimal places and contain a value between $0.00 and $100.00. Therefore, after normalization, if the value sent by the card processor 110 is outside such a range (e.g., less than $0.00 or greater than $100.00), then a suitable error message can be sent by the system 100 to the card processor 110 providing notification of the error and, if necessary, a request for corrected data. Additionally, a suitable record of the error can be maintained by the card product management system 100 (e.g., in an appropriate error log or the like). Other like suitable data verification and validation techniques can be performed by the client application server module 115 on the normalized data received from each card processor 110. Those of ordinary skill will recognize that the data verification and validation can be performed by the client application server module 115 either before or after normalization of the data into the format supported by the card product management system 100.

Any suitable type of information associated with the card products can be communicated between the agent portal module 105 and the plurality of card processors 110, including, for example, financial information, status, queries, and any other appropriate responses and replies, as well as information for managing and administering the card products, such as information related to users, enrollment, and the like. As discussed previously, the format of the messages and the information or data contained within those messages will depend on numerous factors, such as, for example, the communication protocol used by the card processors 110, the nature and type of information associated with the card products, and other like factors. According to an exemplary embodiment of the present invention, the information received from each card processor 110 can comprise a plurality of reports. For example, a single report can contain all or substantially all of the relevant information associated with one or more card products maintained by the card product management system 100. Alternatively, multiple reports can be used, with each report containing a predetermined subset of information associated with the one or more card products.

For example, according to one exemplary embodiment of the present invention, three such reports can be used to communicate information associated with card products, such as, for example, a “general” report, a “posted” report, and an “authorization” report. The general reports can include any suitable general or non-financial data associated with the card products, including, for example, names and addresses of cardholders, demographic data associated with cardholders, status of card products, and other like information. However, the general reports can also include any suitable financial data, such as, for example, card balances and the like. The posted reports can include any suitable information regarding posted transactions, such as, for example, a listing of posted transactions from the previous business day or the like. The authorization reports can include any suitable information regarding authorizations of financial or other transactions, including, for example, authorization attempts, non-settled transactions and the like. However, any suitable number of reports, each containing any appropriate type of information, can be used to communicate information associated with the card products, for example, from the card processors 110.

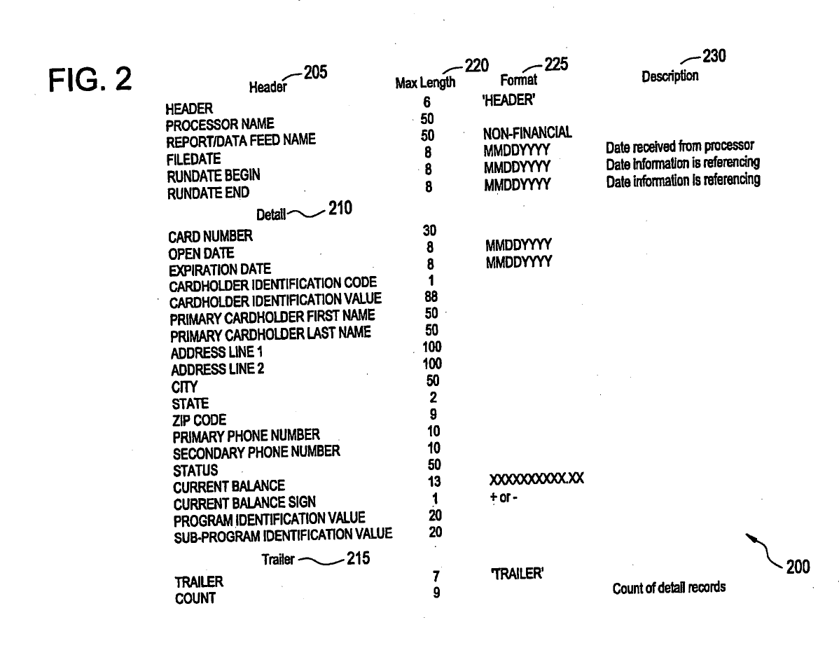

For example, FIG. 2 is report specification for a general or non-financial report 200, in accordance with an exemplary embodiment of the present invention. The general report 200 includes several sections, including a header section 205, a detail (body) section 210, and a trailer section 215. The report specification illustrated in FIG. 2 describes the fields that can populate the header section 205, the detail section 210 and the trailer section 215, as well, for example, the maximum length 220 of each field, the format 225 of each field, and the description 230 of each field within each of the sections. The header section 205 can include any suitable header fields, such as, for example: HEADER (e.g., to specify the start of the header section 205); PROCESSOR NAME (e.g., name of the card processor 110); REPORT/DATA FEED NAME (e.g., to specify the report as a general or non-financial report 200); FILEDATE (e.g., the date the report is received from the processor); RUNDATE BEGIN (e.g., the beginning date that the information in the general report 200 is referencing); and RUNDATE END (e.g., the ending date that the information in the general report 200 is referencing). Additional and/or alternative fields can be included in the header section 205.

The detail section 210 can include any suitable detail or body fields, such as, for example: CARD NUMBER (e.g., the number on the plastic issued to the cardholder); OPEN DATE (e.g., the date the particular card was opened); EXPIRATION DATE (e.g., the expiration date of the card); CARDHOLDER IDENTIFICATION CODE (e.g., a code used to identify the cardholder identification value, such as, for example, “1” for social security number, “2” for drivers license number, “3” for matricular consular number, “4” for passport, “5” for visa, “6” for green card or the like); CARDHOLDER IDENTIFICATION VALUE (e.g., a value used to identify a customer); PRIMARY CARDHOLDER FIRST NAME; PRIMARY CARDHOLDER LAST NAME; ADDRESS LINE 1; ADDRESS LINE 2 (e.g., first and second lines of cardholder's address); CITY; STATE; ZIP CODE (e.g., city, state and zip code of cardholder's address); PRIMARY PHONE NUMBER; SECONDARY PHONE NUMBER (e.g., cardholder's primary and secondary phone numbers); STATUS (e.g., status of a particular card); CURRENT BALANCE (e.g., current balance on the card); CURRENT BALANCE SIGN (e.g., sign if balance is positive (+) or negative (−)); PROGRAM IDENTIFICATION VALUE (e.g., a processor assigned value, if applicable); and SUB-PROGRAM IDENTIFICATION VALUE (e.g., a processor assigned value, if applicable). According to an exemplary embodiment, the CARDHOLDER IDENTIFICATION VALUE field be comprised of a concatenation of sub-fields, including, for example: VALUE (e.g., up to 25 alphanumeric characters specifying an identification value); COUNTRY (e.g., up to 2 alphanumeric characters specifying the country of issuance of the identification); EXPIRATION DATE (e.g., specified as MMDDYYY, MMYYY, YYYY or the like); and COMMENTS (e.g., up to 50 alphanumeric characters specifying comments). Additional and/or alternative fields and sub-fields can be included in the detail section 210. Any suitable number of cards or card products can be conveyed in the general report 200, and each card or card product (e.g., each account associated with each card or card product) can have a detail record in the detail section 210.

The trailer section 215 can include any suitable trailer fields, such as, for example: TRAILER (e.g., to specify the start of the trailer section 215); and COUNT (e.g., to specify the number or count of detail records contained in the detail section 210). Additional and/or alternative fields can be included in the trailer section 215.

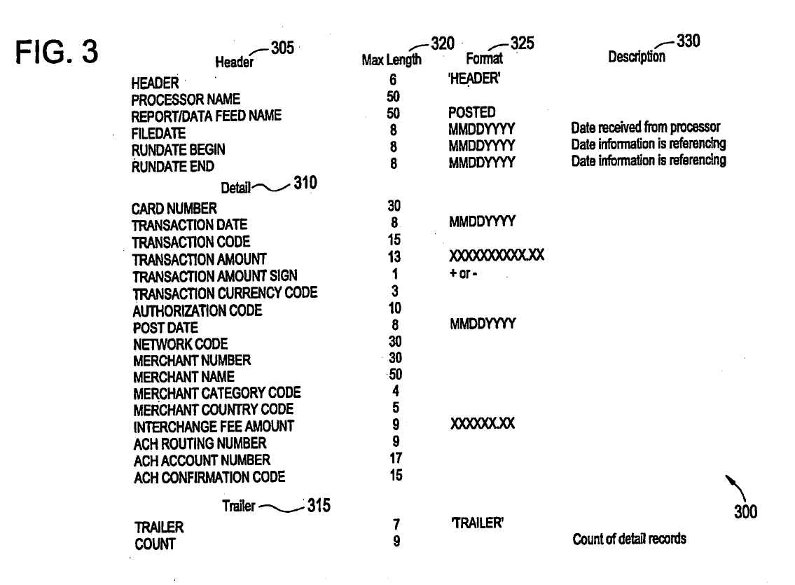

For example, FIG. 3 is report specification for a posted report 300, in accordance with an exemplary embodiment of the present invention. The posted report 300 includes several sections, including a header section 305, a detail (body) section 310, and a trailer section 315. The report specification illustrated in FIG. 3 describes the fields that can populate the header section 305, the detail section 310 and the trailer section 315, as well, for example, the maximum length 320 of each field, the format 325 of each field, and the description 330 of each field within each of the sections. The header section 305 can include any suitable header fields, such as the same or different header fields as specified for the header section 205 of the general report 200 (e.g., with the value of the REPORT/DATA FEED NAME field specifying the report as a posted report 300).

The detail section 310 can include any suitable detail or body fields, such as, for example: CARD NUMBER (e.g., the number on the plastic issued to the cardholder); TRANSACTION DATE (e.g., the date of the original transaction); TRANSACTION CODE (e.g., a code representing the type of monetary transaction); TRANSACTION AMOUNT (e.g., the amount of the transaction that posted to the card); TRANSACTION AMOUNT SIGN (e.g., sign if transaction is positive (+) or negative (−), with negative sign designates removing funds, while positive sign designates adding funds); TRANSACTION CURRENCY CODE (e.g., a code representing the currency of the transaction amount); AUTHORIZATION CODE (e.g., the identification number assigned to the approved transaction, and can be blank if the authorization request was declined); POST DATE (e.g., the date the transaction posted to the card); NETWORK CODE (e.g., the code identifying the Network (e.g., Pulse, NYCE, STAR or the like) rails used to process the transaction); MERCHANT NUMBER (e.g., a number identifying the merchant submitting the transaction); MERCHANT NAME (e.g., the name of merchant accepting the original transaction); MERCHANT CATEGORY CODE (e.g., a code representing the merchant's line of business); MERCHANT COUNTRY CODE (e.g., a code representing the country where the merchant's business is located); INTERCHANGE FEE AMOUNT (e.g., the amount of interchange associated with the present transaction); ACH ROUTING NUMBER (e.g., routing number where funds will be distributed); ACH ACCOUNT NUMBER (e.g., account number where funds will be distributed); and ACH CONFIRMATION NUMBER (e.g., a confirmation code for the ACH transaction that can appear on the cardholder's statement where the funds are being distributed). Additional and/or alternative fields and sub-fields can be included in the detail section 310. The trailer section 315 can include any suitable trailers fields, such as the same or different trailer fields as specified for the trailer section 215 of the general report 200.

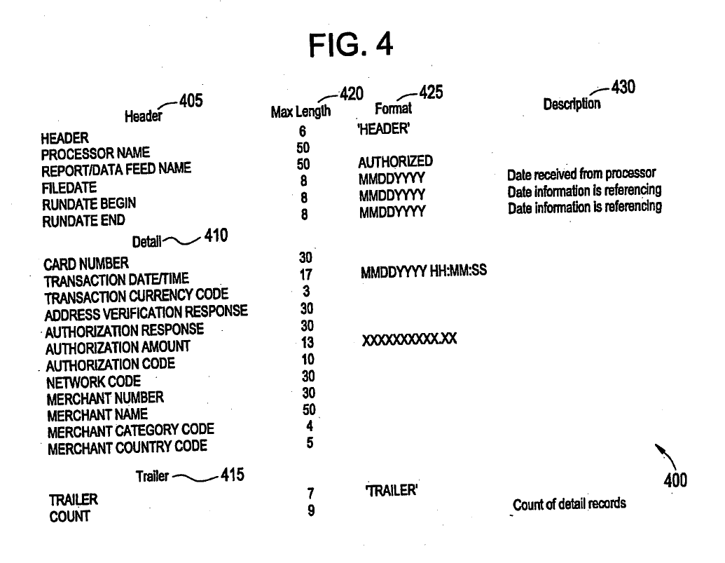

For example, FIG. 4 is report specification for an authorization report 400, in accordance with an exemplary embodiment of the present invention. The authorization report 400 includes several sections, including a header section 405, a detail (body) section 410, and a trailer section 415. The report specification illustrated in FIG. 4 describes the fields that can populate the header section 405, the detail section 410 and the trailer section 415, as well, for example, the maximum length 420 of each field, the format 425 of each field, and the description 430 of each field within each of the sections. The header section 405 can include any suitable header fields, such as same or different header fields as specified for the header section 205 of the general report 200 (e.g., with the value of the REPORT/DATA FEED NAME field specifying the report as an authorization report 400).

The detail section 410 can include any suitable detail or body fields, such as, for example: CARD NUMBER (e.g., the number on the plastic issued to the cardholder); TRANSACTION DATE/TIME (e.g., the date and time of the original transaction); TRANSACTION CURRENCY CODE (e.g., a code representing the currency of the transaction amount); ADDRESS VERIFICATION RESPONSE (e.g., a message representing the response if address verification was utilized); AUTHORIZATION RESPONSE (e.g., a message representing why the request was authorized or declined); AUTHORIZATION AMOUNT (e.g., the amount of the authorization request); AUTHORIZATION CODE (e.g., the identification number assigned to the approved transaction, and can be blank if the authorization request was declined); NETWORK CODE (e.g., the code identifying the Network (e.g., Pulse, NYCE, STAR or the like) rails used to process the transaction); MERCHANT NUMBER (e.g., a number identifying the merchant submitting the transaction); MERCHANT NAME (e.g., the name of merchant accepting the original transaction); MERCHANT CATEGORY CODE (e.g., a code representing the merchant's line of business); and MERCHANT COUNTRY CODE (e.g., a code representing the country where the merchant's business is located). Additional and/or alternative fields and sub-fields can be included in the detail section 410. The trailer section 415 can include any suitable trailers fields, such as the same or different trailer fields as specified for the trailer section 215 of the general report 200.

As discussed above, BINs are assigned to card processors 110 by card issuers. For example, a BIN or other unique identifier can be assigned to each card processor 110 by MASTERCARD™ or VISA™ or other card issuers. The card processors 110 associate BINs to the card products. The BINs can be used to uniquely identify the card processor 110 that services and/or processes a particular card product. For the illustration of bank-issued gift cards or the like with sixteen-digit card product numbers, the first six digits of the card product number can comprise the BIN, although any suitable number of digits can be used to specify the BIN. Conventionally, the remaining digits of the card product number can be used to uniquely identify a user (e.g., the cardholder), and are also assigned by the card processors 110. For the illustration of bank-issued gift cards or the like, the remaining (e.g., ten) digits are commonly used for assigning a BIN extension (e.g., six digits), a card number (e.g., three digits), and a check bit (e.g., one digit). The entire card product number thereby uniquely identifies both the card processor 110 that services and/or processes the card product and the cardholder of that card product.

However, according to an alternative exemplary embodiment of the present invention, the client application server module 115 can be configured to allocate and assign card numbers corresponding to each BIN (or other unique identifier) for the card products. More particularly, the card product number can be comprised of two portions of digits—a first portion of digits and a second portion of digits. For purposes of illustration and not limitation, for a sixteen digit card product number for, for example, a bank-issued gift card or the like, the first portion of digits can include the first six digits of the card product number, while the second portion of digits can include the remaining ten digits. The first portion of digits can comprise the BIN (or other suitable unique identifier). For each BIN, the second portion of digits can be used to assign card numbers for the given BIN. The client application server module 115 can allocate card numbers comprising all or substantially all of the second portion of digits for each BIN, although the client application server module 115 can use any subset of the second portion of digits to allocate card numbers.

In other words, according to an exemplary embodiment, the client application server module 115 can be configured to allocate and assign card numbers for each BIN (or other suitable unique identifier) by using all or substantially all of the remaining digits other than the BIN in a card product number. For the example of a sixteen-digit card product number with a six-digit BIN, the remaining ten digits (or any subset thereof) can be used to assign any of one billion card numbers for a particular BIN. Consequently, for a sixteen-digit card product number with a six-digit BIN and ten remaining digits, up to one billion card products can be issued for each card processor 110, although the number of available card numbers will depend on such factors as, for example, the length of the card product number used, the length of the BIN or other identifier that forms part of the card product number, and other like factors. Thus, a “non-processor,” in particular the card product management system 100 according to exemplary embodiments, can allocate and assign values (e.g., card numbers) to the entire second portion of digits, or any subset thereof, of the card product number of each card product. For example, the card numbers for the second portion of digits can be allocated sequentially or randomly for each BIN. Accordingly to an exemplary embodiment, the first portion of digits can precede the second portions of digits within each card product number. According to an alternative exemplary embodiment, the second portion can precede the first portion of digits. Alternatively, the first and second portions of digits can be suitably interleaved or mixed within the card product number. The length (in digits) of the card product number and the sizes of the corresponding first and second portions of digits will depend on such factors as, for example, the type of card number used for each card product, the size or length (in digits) of the BIN or other unique identifier, the size or length (in digits) of corresponding card numbers, and other like factors. According to a further exemplary embodiment, the client application server module 115, rather than the card issuers, can allocate and assign the BINs to each card processor 110.

Suitable and appropriate methods and mechanisms can be used to ensure the safety and security of the information communicated between the agent portal module 105 and the card processors 110. For example, secure connections (e.g., via HTTPS or the like) can be maintained between the agent portal module 105 and each of the card processors 110. Additionally or alternatively, the data and information can be suitably encrypted using any appropriate encryption or cryptographic algorithm or technique, including, for example, any suitable public key infrastructure (PKI) system, RC4, MD5, base64 encoding or the like.

Messages communicated to the card processors 110 can include, for example, a query or the like that includes a computer network address (e.g., a URL, IP address or the like) of a file. For example, the query can comprise a conventional search query sent by the agent portal module 105 to obtain a file or other data located at a particular website URL or other unique address. However, if intercepted, a malicious hacker or intruder can potentially tamper with the query. For example, the URL or computer network address could be modified to obtain a different file or data, such as a secure file or data that is not meant to be accessed or obtained by the card processors 110. Such malicious activity could render data maintained by the card processors 110 and the card product management system 100 vulnerable to theft or corruption.

According to an exemplary embodiment, to address such security issues, the computer network address contained in the query can be encrypted. The encrypted computer network address is then appended to the end of the query. By appending the encrypted computer network address to the end of the query, the query can be processed (e.g., by the card processors 110) in a conventional manner (while ignoring the appended encrypted computer network address) to obtain the file or data at the specified computer network address. The response to the query (e.g., sent to the agent portal module 105) can also include the query itself, with the computer network address and encrypted computer network address in the response. The client application server module 115 is configured to detect tampering with the computer network address by decrypting the encrypted computer network address, and then comparing the computer network address and the decrypted computer network address. If both computer network addresses are the same, no tampering has occurred. However, if the computer network address does not match the decrypted computer network address, tampering has occurred. In such an instance, suitable security measures can be undertaken (e.g., deletion of the message), and appropriate alerts and warnings can be communicated to affected clients.

According to an alternative exemplary embodiment, the client application server module 115 is configured to detect tampering with the computer network address by re-encrypting the computer network address, and then comparing the re-encrypted computer network address and the originally-encrypted computer network address (that had been appended to the end of the query). If the original and newly-encrypted computer network addresses are different, then tampering has occurred. For purposes of illustration and not limitation, to create an encrypted computer network address according to such an alternative exemplary embodiment, a MD5 hash of a RC4 encryption of the query string of a URL can be performed to generate an encrypted hash. The encrypted hash can be appended to the query string as a unique key-value pair. To check the validity of an encoded query string, the unique key-value pair hash can be removed from the query string. A MD5 hash of a RC4 encryption of the remaining query string can be created. The result of the encryption can be compared to the unique key-value that was previously removed from the query string. If the two encrypted hashes are different, then tampering of the query string has occurred.

Any suitable encryption technique can be used to encrypt the computer network address. For example, according to an exemplary embodiment, a cryptographic hash function can be used. As illustrated previously, the computer network address can be encrypted (e.g., using RC4, MD5, base64 or the like or any suitable combination thereof) to generate a encrypted computer network address. A suitable hash function can then be applied to the encrypted computer network address to generate an encrypted hash. Although computer network addresses have been discussed, it is noted that any suitable data within the query, including the entire query itself or any part thereof, can be encrypted and appended to the end of the query for purposes of detecting tampering according to the exemplary embodiment.

To maintain and administer the card products, the card product management system 100 includes a database module 120 in communication with the client application server module 115. The database module 120 is configured to store, for example, information associated with the card products and other like information. The client application server module 115 can query or otherwise access the database module 120 to store or retrieve such information according to requests from users, the card processors 110, or the system 100 itself. For example, the database module 120 can be used to store tables of card numbers corresponding to each BIN and other like information to support the management and administration of card products. The database module 120 can be any suitable type of computer database or storage medium or memory, database product (e.g., SQL) that interacts with any such medium or memory, or other like electrical or electronic storage device or facility that is capable of storing electrical and electronic information for later retrieval.

According to exemplary embodiments, card processors 110, cardholders, administrators, and other entities and individuals (collectively referred to as “users”) can access information regarding card products through the card product management system 100. In other words, the agent portal module 105 is configured to allow access by users to manage information associated with the card products. To support such access, the agent portal module 105 includes a graphical user interface module 130. The graphical user interface module 130 is configured to display, either locally or remotely, a graphical user interface (GUI) through which users can interact with the card product management system 100. The GUI can be, for example, a proprietary graphical interface, any suitable Web browser (e.g., Internet Explorer, Netscape, Firefox, Safari, Opera, or any other suitable Web browser) or other like interface that is capable of displaying graphical and/or textual information, and can support secure connections and remote access to the card product management system 100. For example, a Personal Computer (PC) 140 or other suitable type of computer system or device (e.g., laptop, personal digital assistant (PDA), cellular phone or the like) can be used by a cardholder 143, a financial institution 147 or other like user to remotely access information regarding card products through the card product management system 100 using the GUI of the graphical user interface module 130, for example, through a suitable Web browser via a secure connection over the Internet or World Wide Web.

The GUI can support a login screen that prompts users to enter a username (or e-mail address) and a uniquely-assigned password to gain initial access to the card product management system 100 upon successful entry of both. Passwords can be encrypted using any suitable encryption technique (e.g., MD5 or the like), and users can be locked out of the system after three unsuccessful attempts to log in. Other suitable additional or alternative security measures can be used for logging into the system 100, including, for example, biometrics and the like. According to an exemplary embodiment, the graphical user interface module 130 is configured to determine the computer network address of the user (e.g., the IP address of the computer from which the user is accessing the system 100). As an additional security feature, the graphical user interface module 130 can compare the computer network address of the user with a computer network address that has been stored for the user's username (e.g., an IP address that is entered or otherwise recorded for the user at the time of enrollment or registration with the system 100). In addition to the username and password, if the computer network address of the user does not match the recorded computer network address corresponding to the user's username, then access to the card product management system 100 can be denied. Thus, the user can be granted access to the card product management system 100 through the GUI using both or either of the password and the associated computer network address of the user.

The card product management system 100 is a role-based system. In other words, the functionality, features and information presented to and accessible by each user through the GUI can be based on the user's established role with the system 100. For example, a cardholder can be given access to and manage information that pertains only to the card products held by the cardholder. In contrast, a card processor 110 can be given access to and manage information that pertains to all card products issued by that card processor 110. However, an administrator of the card product management system 100 can be given access to and manage information that pertains to all card products maintained by the system 100. In each instance, the GUI is configured to allow the given user to access only those features, functionality and information that are appropriate for the user given that user's role in the card product management system 100.

To assist in such a delineation of functionality between various users, each type of user can access the card product management system 100 via different website addresses (e.g., URLs). For example, cardholders can access the system 100 by navigating their Web browsers to a site such as, for example, “myprepaidbalance.com” or “myprepaidaccount.com” or other suitable website address. Card processors 110 can access the system 100 by directing their Web browsers to a different address, such as, for example, “prepaidadmin.com” or other suitable website address. Although different URLs can be used for each type of user, each website address still leads the respective user into the card product management system 100, albeit through different entrance points.

Additionally or alternatively, the GUI can be configured to present a different theme, appearance or “skin” to the user, depending on the user's role and/or affiliation with a card processor 110. For example, based on the user's identification via their corresponding username and password (and, if desired, computer network address), the graphical user interface module 130 can change the configuration of the appearance of the GUI displayed to the user. For example, for cardholders, the GUI can be quite “showy” or otherwise elaborately decorated to enhance the cardholder's experience. In addition, advertisements, promotions, marketing information, usage tips, navigation information and the like of potential interest to the cardholder can be displayed through the GUI to the cardholder. In contrast, an administrator can be presented with a GUI that is more “stark,” focusing on features and functionality, rather than on elaborate presentation. Furthermore, each card processor 110 can have an associated theme or “skin” for the GUI. Thus, when a card processor 110 logs into the card product management system 100 through the GUI, the corresponding graphical theme or “skin” of that card processor 110 can be displayed. Such a theme or “skin” can also or alternatively be presented to users (e.g., cardholders) when managing card products issued by that card processor 110.

Upon gaining access, users of the card product management system 100 can view and manage the information associated with card products. The card product management system 100 is configured to allow users to perform those functions associated with managing card products. For example, for a “plastic order,” users can order the plastic cards that are (ultimately) distributed to cardholders, including specifying the design or layout of the cards, providing custom messages to appear on the cards, and other like features of the cards. Once the user has purchased the actual, plastic cards through the system 100, the cards can be loaded with value (e.g., a dollar amount), activated and issued. For the illustration of gift cards, using an “instant issue,” an individual card can be assigned, for example, a card number, expiration date, load amount, CVV2/CVC2 number, security code and other identifying information. The individual card can then be registered using the cardholder's name, address, telephone number and the like. The card is then ready for use by the cardholder. In addition, a “bulk order” can be considered a combination of “plastic order” and “instant issue.” For a bulk order, the plastic cards are ordered and can be pre-loaded with a monetary amount that can be accessed upon activation of the cards. Thus, such bulk orders can allow a user to both specify card load amounts at the time of order and to personalize/customize those cards for sale or distribution.

It is noted that any suitable types of card or card-based products can be offered or otherwise sold or distributed through the card product management system 100. For a particular type of card product, each of the individual cards of the given card product type can be serviced and/or processed by any of the card processors 110. In other words, one card product type can use multiple card processors 110. For example, assume that a card issuer has a card stock of card product type X. A first order of cards of card product type X can be assigned a first BIN or other unique identifier to be serviced and/or processed by the first card processor 110. A second order of cards of card product type X can be assigned a second BIN or other unique identifier to be serviced and/or processed by the second card processor 110. A third order of cards of card product type X can be assigned a third BIN or other unique identifier to be serviced and/or processed by the third card processor 110. Thus, although each individual card is serviced and/or processed by a particular card processor 110, any of the card processors 110 can be chosen to service and/or process the cards of a particular card product type.

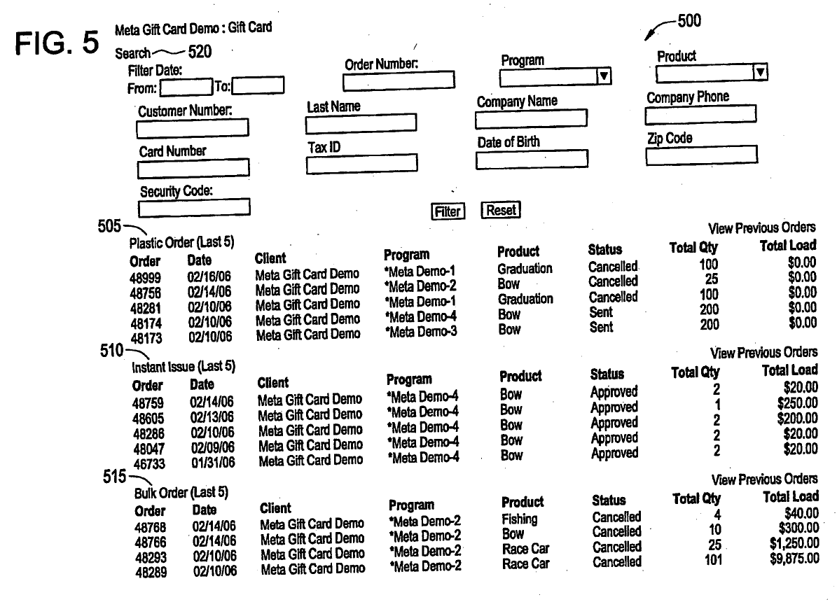

The card product management system 100 can allow the user to view previous orders. For example, FIG. 5 is an example of a graphical user interface (GUI) 500 for viewing orders through the card product management system 100, in accordance with an exemplary embodiment of the present invention. The GUI 500 can display suitable information to summarize, for example, all or the most recent orders for plastic orders 505, instant issues 510 and bulk orders 515. The summarized information can include, for example, order number, date of order, client name, program name, product name, status of order, total quantity of cards ordered, total load amount and any other suitable information. In addition, a search field 520 is configured to allow the user to search and filter (using standard searching and filtering algorithms and techniques) the order history according to any of the previous mentioned summarized information, and including such additional fields as customer number, cardholder name, company name, company phone, card number, tax ID, cardholder's date of birth, zip code, security code and the like. By using such searching/filtering, the user can view any desired level of granularity of the card product information, from individual cards to entire card orders across any or all of the card processors 110.

The card product management system 100 is also configured to generate reports for the information associated with the card products. For example, the client application server module 115 can format the reports based on user requests, which can then be displayed through the GUI by the graphical user interface module 130. Any suitable type of report can be provided by the system 100 to the user including, for example, an order summary for the user, a total sales summary, a total sales summary by branch, a plastic order summary, an inventory summary, card details, a listing or summary of ACH requests and the like. According to an exemplary embodiment, each report can be populated with information in accordance with the identification of the user. In other words, once logged into the system 100, the identity of the logged-in user is known to the card product management system 100 via the user's username and password. Since the user's identity is known, card product information for that user can be presented or otherwise displayed to that user through the GUI, for example, in the form of reports. In addition, because the user' identity is known, the GUI itself can be configured to display other information associated with the given user, such as, for example, a list of products available to that user, GUI menu functions (e.g., pull-down or pop-up menus and sub-menus) that are available to that user, and the like. For example, card products can be presented to the user through the GUI based on the user's identification and the user's association or affiliation with a financial institution such as a card processor 110. Thus, the card product management system 100 can tailor the interface and information presented to each user (e.g., based on the user's identity) to improve the ease of use of and accessibility to the system 100 and the card product information maintained by the system 100.

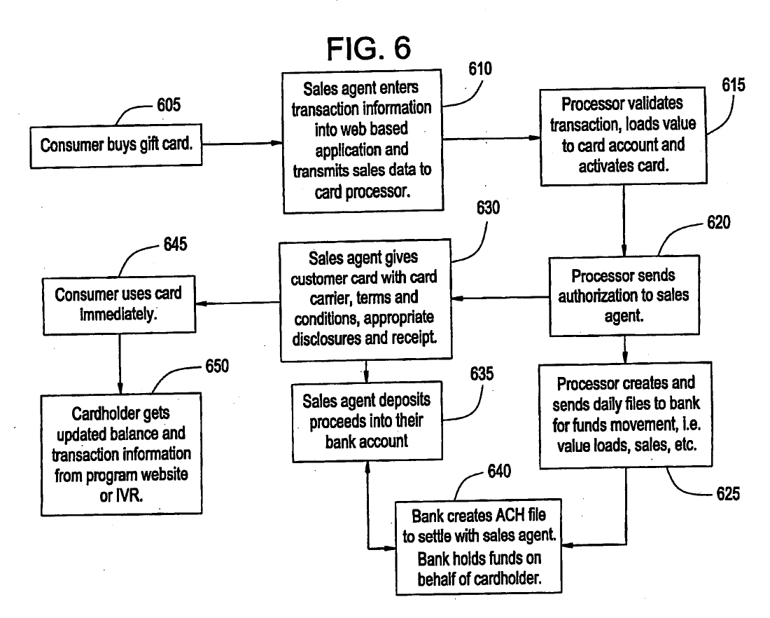

For purposes of illustration and not limitation, FIG. 6 is a diagram illustrating a transaction flow for a gift card issued by a card processor 110, in accordance with an exemplary embodiment of the present invention. FIG. 6 illustrates the interaction between cardholders, sales agents (e.g., those who sell and distribute cards at points of sale), processors and the card product management system 100. In block 605, the consumer purchases a gift card from a sales agent at the point of sale. In block 610, the sales agent enters the transaction information into the Web-based application (e.g., the GUI) of the card product management system 100 and transmits the sales data to the card processor 110 who issues the given gift cards. In block 615, the card processor 110 validates the transaction, loads value to the card account and activates the card. In block 620, the card processor 110 transmits an authorization back to the sales agent. In block 625, the card processor 110 creates and sends daily files to the financial institution (e.g., a bank or the like) for funds movement, including value loads, sales, and the like. In block 630, the sales agent gives the customer the (loaded and activated) gift card, appropriate fee disclosures and cardholder agreements, receipt and the like. According to an exemplary embodiment, such (printed) consumer disclosures can be viewed electronically by the consumer or other user through the system 100 via the GUI, as the system 100 is configured to electronically store (e.g., in the database module 120) such disclosures and other documentation for access by users.

In block 635, the sales agent deposits the proceeds of the sale into the sales agent's bank account. In block 640, the bank or other financial institution creates an ACH file to settle with the sales agent, and holds the finds on behalf of the cardholder. After the consumer is given the “live” gift card in block 630, then in block 645 the consumer (now cardholder) can use the card immediately to purchase goods and services at millions of locations where the major brand of the gift card is accepted. In block 650, the cardholder can interact with the card product management system 100 through the GUI to get updated card balance information (e.g., via a URL listed on the back of the gift card). According to an alternative exemplary embodiment, the cardholder can interact with the system 100 through a telephone using a suitable interactive voice response (IVR) system or the like, instead of the GUI.

Referring to FIG. 1, the card product management system 100 includes a management application server module 125. The management application server module 125 is in communication with the database module 120. According to exemplary embodiments, the management application server module 125 is configured to manage any and all aspects of the card product management system 100 and the card products maintained by the system 100. For example, the management application server module 125 is configured to monitor card product activity and provide sales and exception reporting on a daily basis. For example, sales activity that appear on multiple exception reports can be reviewed for possible suspicious activity. Exception reports can include, for example, high-dollar transactions, velocity checks for value loads and transactions, excessive credits or returns, foreign transactions and other like activity that may be suspicious. In addition, balance and inactivity timeframes for each card product can be monitored daily by the management application server module 125. Transaction settlements are automated, and funding account balances can be monitored daily for adequacy by the management application server module 125. The management application server module 125 is configured to monitor any and all card product accounts and automate the escheatment process on a state by state basis. Thus, the management application server module 125 can monitor, track and report on card processors 110, users, programs, vendors, contracts and the like on a daily or other timely basis.

Administrators and other appropriate users can access and manage the system 100 and view information associated with card products using the management application server module 125 via a suitable GUI, such as the same or different GUI provided by the graphical user interface module 130 of the agent portal module 105. According to an exemplary embodiment, the GUI for the management application server module 125 is a separate GUI that is provided by a second graphical user interface module or the like that is a component of the management application server module 125. However, the graphical user interface module 130 can provide GUIs for both the agent portal module 105 and the management application server module 125.

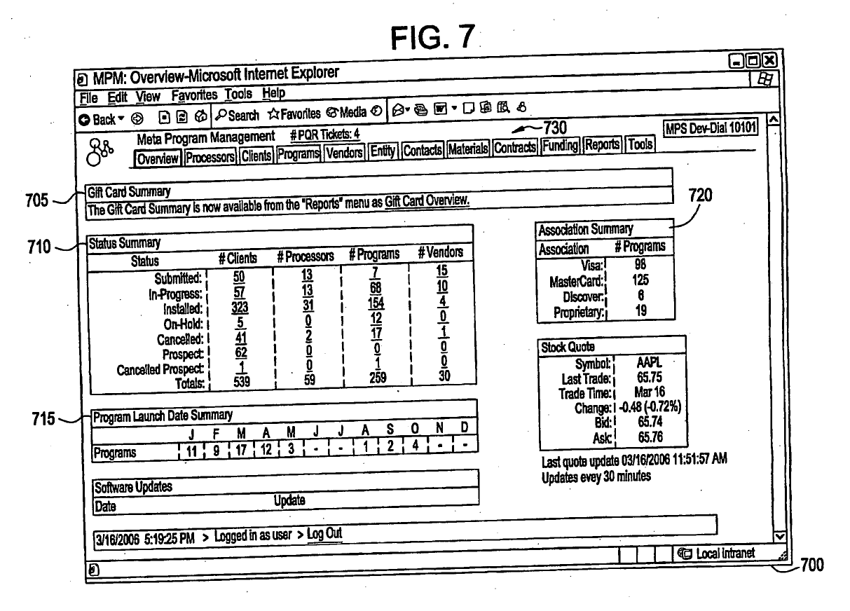

The management application server module 125 can display any suitable information to administrators and other like users in any appropriate format or configuration for managing the card product management system 100. For example, FIG. 7 is an illustration of an overview page 700 for the management application server module 125, in accordance with an exemplary embodiment of the present invention. The overview page 700 can provide brief summary information on, for example, counts of card processors 110, clients, program and vendors by status, card product data, and program breakdown by association. For example, the overview page 700 can display a card summary 705, status summary 710, program launch date summary 715, and association summary 720. Other like information can be displayed on the overview page 700, such as, for example, a card product (e.g., gift card) summary or the like. The overview page 700 is configured to display a top-level menu 730 of other pages to which the administrator can navigate to obtain more detailed information, including tabs for accessing, for example, “Processors,” “Clients,” “Programs,” “Vendors,” “Entity,” “Contacts,” “Materials,” “Contracts,” “Funding,” “Reports,” “Tools,” and other suitable information. Several of such exemplary menu items will be discussed.

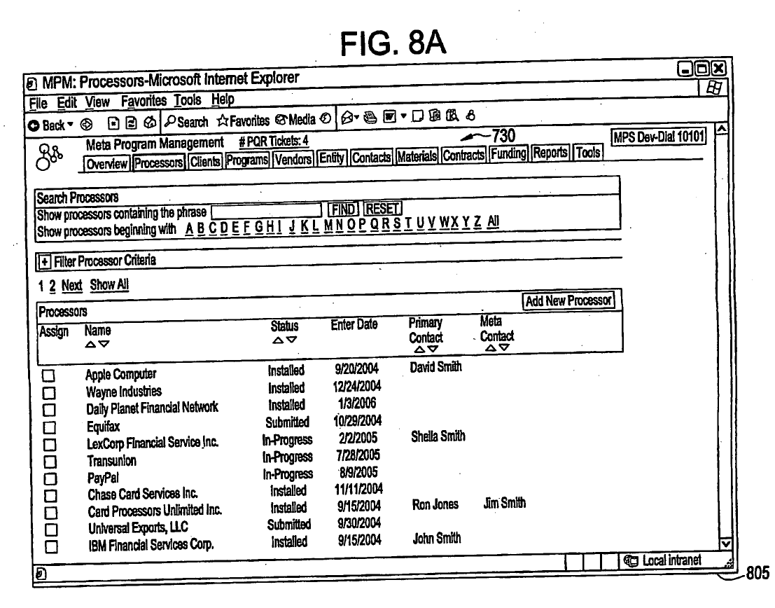

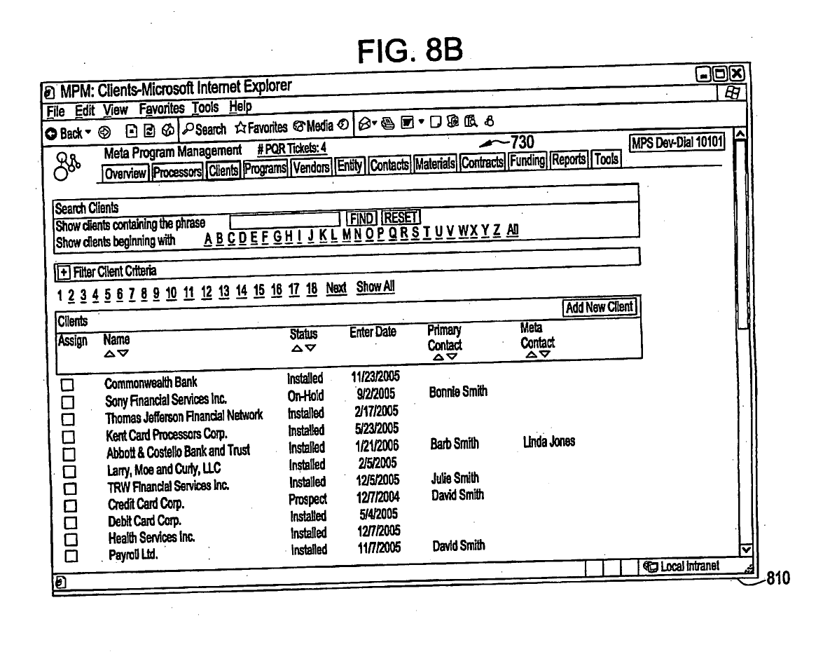

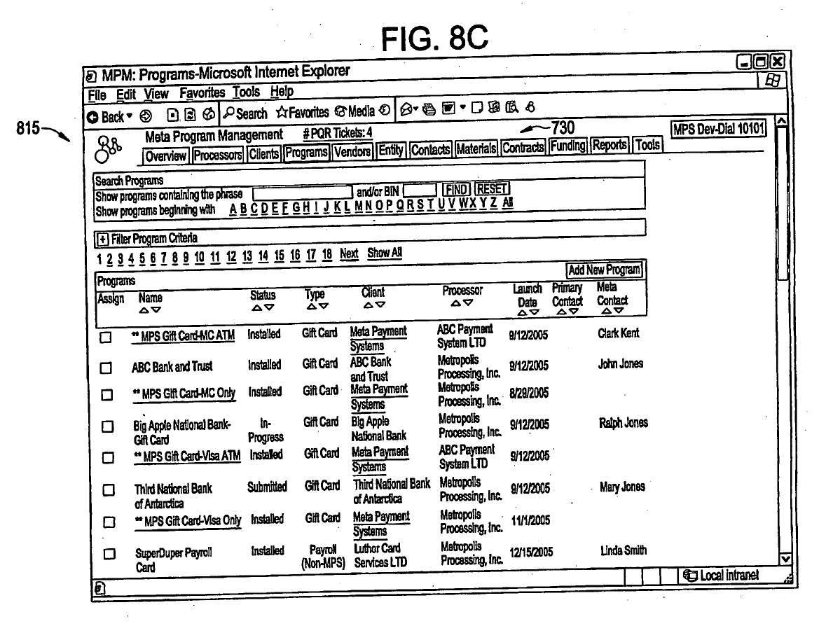

Selecting the “Processors,” “Clients,” “Programs,” or “Vendors” tabs can bring the administrator to a listing page for that entity type. FIGS. 8A, 8B and 8C illustrate a processor page 805, a clients page 810 and a programs page 815, respectively, in accordance with an exemplary embodiment of the present invention. Each such listing page can provide the ability to quickly search for or navigate to the appropriate detailed information. Each listing page lists data such as, for example, the name and relevant summary data for each entity. According to an exemplary embodiment, clicking or otherwise selecting the entity name (e.g., via mouse or suitable pointer device input) from the list can take the administrator to a detailed page for that entity.

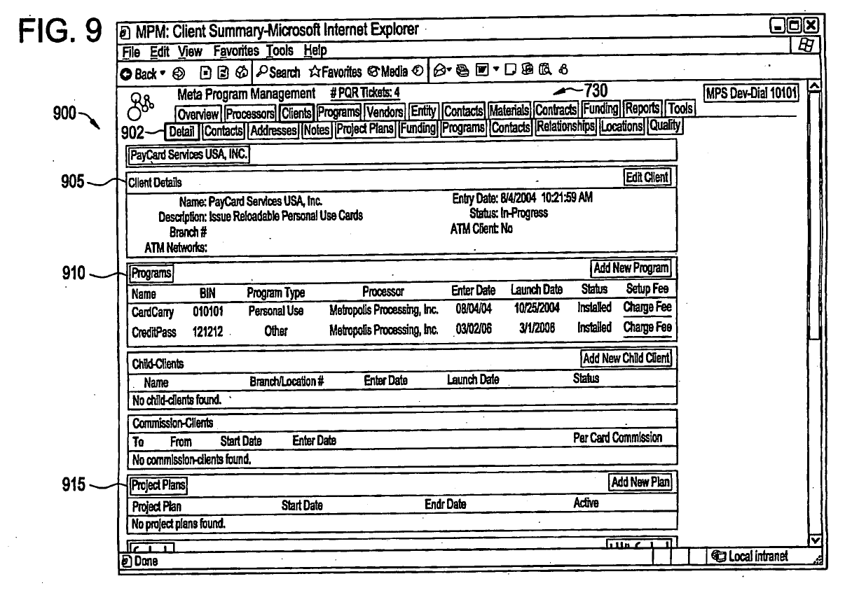

For example, FIG. 9 illustrates a client detail page 900, in accordance with an exemplary embodiment of the present invention. The client detail page 900 can be accessed by, for example, selecting the “Clients” tab in the top-level menu 730 and the “Detail” tab 902 in the corresponding sub-menu. Each detail page is configured to provide an overview of the entity, and can be used to add and edit data associated with the entity. For example, client detail page 900 can maintain such data as client detail information 905, client program data 910, client project plans 915 and the like. Other like information can be displayed in the client detail page 900, including, for example, client contacts (e.g., name, title, phone number, contact type and the like), client contracts, client addresses, client statement definitions, client relationships (e.g., agents, co-branders, distributors, locations, marketers, servicers and the like) and other suitable information, such as, for example, client locations, child clients, commission clients and products and the like.

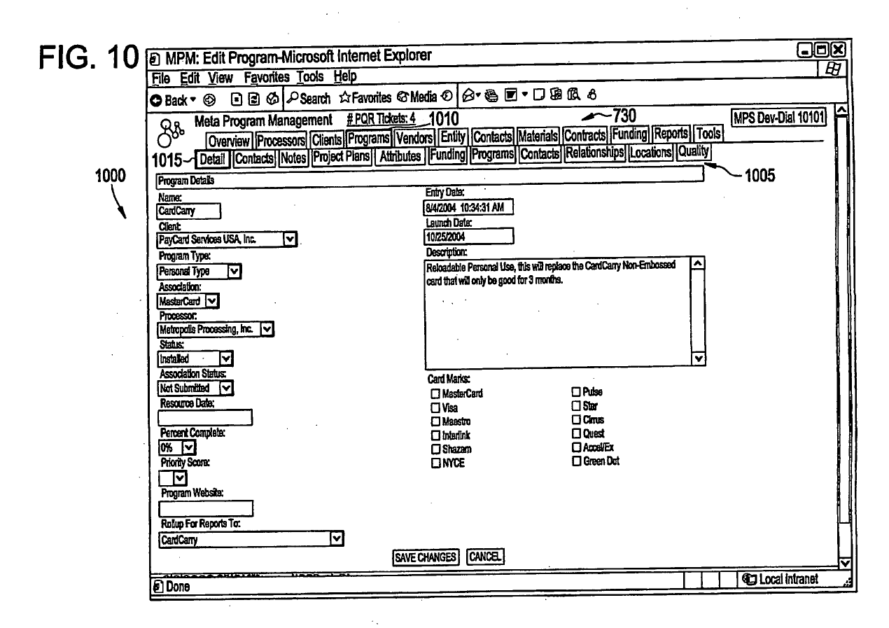

From each tab on the overview page 700, an administrator can drill-down to more detailed information associated with each tab. For example, FIG. 10 illustrates a program details page 1000, in accordance with an exemplary embodiment of the present invention. By selecting the “Programs” tab in the top-level menu 730, the administrator can be presented with an appropriate sub-menu 1005 of page listing options for the given tab. For example, for the “Programs” tab 1010, the corresponding sub-menu 1005 can include such additional tabs as “Details,” “Contacts,” “Notes,” “Project Plans,” “Attributes,” “Funding,” “Products,” “Contracts,” “Relationships,” “Locations,” “Quality” and the like. By selecting the “Details” tab 1015 of the sub-menu 1005, the administrator can be presented with the program details page 1000. The program details page 1000 can display any suitable program detail information, such as, for example, name, client, program type, association, processor, status and other like information. The administrator can use such a listing page for adding and editing program information for an entity. Other tabs or items in the sub-menu 1005 can be selected by and displayed to the administrator.

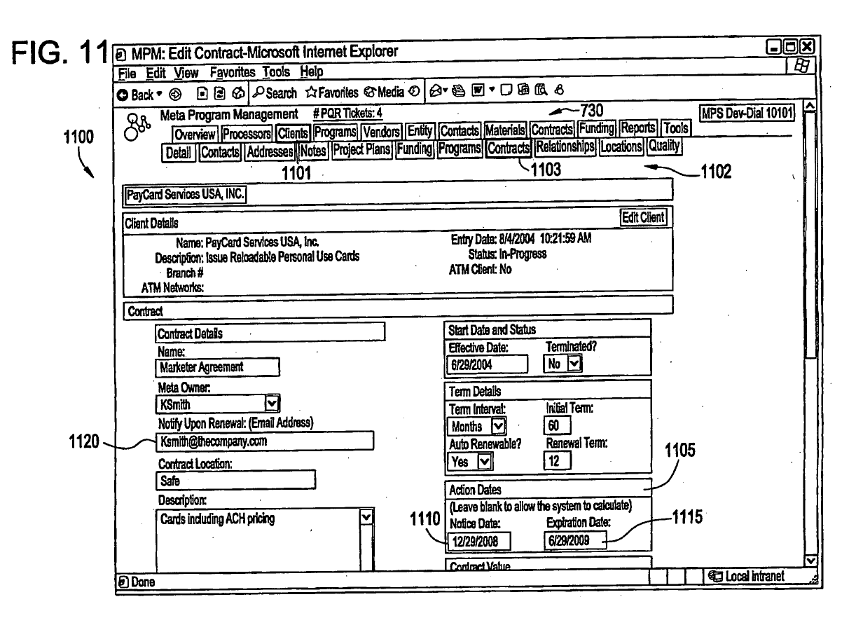

For example, FIG. 11 illustrates a client contracts page 1100, in accordance with an exemplary embodiment of the present invention. By selecting the “Clients” tab in the top-level menu 730, the administrator can be presented with an appropriate sub-menu 1102 of page listing options for the given tab (which can be a similar or different listing of options from sub-menu 1005 illustrated in FIG. 10). For example, for the “Clients” tab 1101, the corresponding sub-menu 1102 can include such additional tabs as “Detail,” “Contacts,” “Addresses,” “Notes,” “Project Plans,” “Funding,” “Programs,” “Contracts,” “Relationships,” “Locations,” “Quality” and the like. By selecting the “Contracts” tab 1103 of the sub-menu 1102, the administrator can be presented with the client contracts page 1100. According to an exemplary embodiment, the administrator can make an entry through the management application server module 125 via the contracts page 1100 when each contract is signed. Information recorded in the contracts page 1100 includes relevant details and dates associated with the contract. For example, action dates 1105 can be provided. A notice date field 1110 under the action dates 1105 can be set to six months (or other suitable time period) prior to the expiration date 1115 to allow for re-negotiation or notice of termination. Once the notice date is reached, the management application server module 125 can send an e-mail or other suitable notification to the user listed as a notify contact 1120, with such notifications being sent daily or periodically until appropriate action is taken. Additionally, an e-mail or other suitable notification can also be sent to the appropriate operations department or personnel to notify them of the new contract and prompt them to enter a statement definition for that contract. Other like information can be displayed in the contracts page 1100, including, for example, accompanying notes that can be added for the contract. Other tabs or items in the sub-menu 1102 can be selected by and displayed to the administrator.

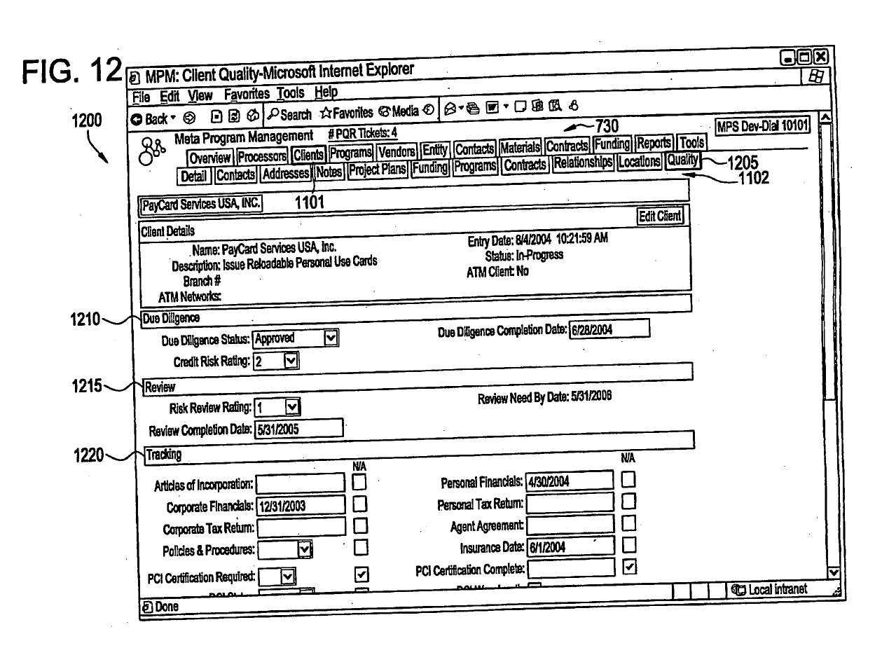

For example, by selecting the “Quality” tab of the sub-menu 1102, the administrator can be presented with the client quality page 1200. FIG. 12 illustrates a client quality page 1200, in accordance with an exemplary embodiment of the present invention. The clients quality page 1200 under the “Quality” tab 1205 can display information for tracking due diligence, quality review and appropriate corporate documentation and other like information for a client. For example, the due diligence section 1210 can be completed when information on the entity is entered. The review section 1215 can provide the card product management system 100 with a date by which a review will be needed based on the client's risk rating. The tracking section 1220 can indicate the documentation and other information required for performing due diligence, and the date of the most recent version of such documentation that is on file. A report can be generated by the management application server module 125 to track what documentation is required annually (or other suitable time frame) from the entity.

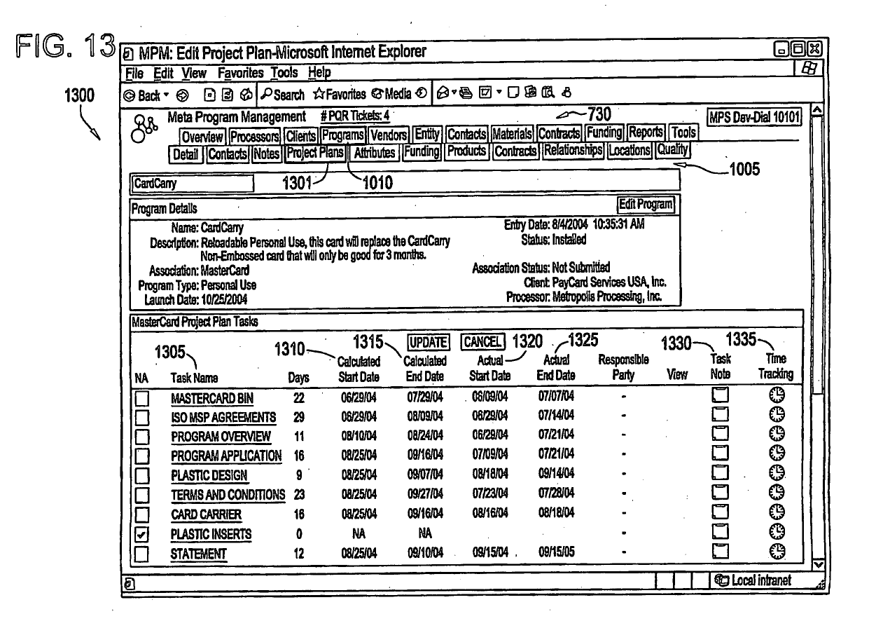

Returning to display or listing options under the “Programs” tab 1010 in the top-level menu 730, FIG. 13 illustrates a program project plans page 1300, in accordance with an exemplary embodiment of the present invention. The project plans page 1300 can be accessed by, for example, selecting the “Programs” tab 1010 in the top-level menu 730 and the “Project Plans” tab 1301 in the corresponding sub-menu 1005. The program project plans page 1300 can guide the administrator through a pre-defined process for setting up a card processor 110 or program. The program plans page 1300 can allow the administrator to enter any suitable project plan task names 1305 corresponding to each task. For example, when a new project plan is created, the management application server module 125 can calculate the start and end dates 1310 and 1315, respectively, for each task name 1305. The administrator can also enter the actual start date and end dates 1320 and 1325, respectively, for each task name 1305. Each task can be disabled if it is not needed by appropriately de-selecting the task name 1305. Notes 1330 can be entered for each task name 1305. Time 1335 can be tracked for each task name 1305, and billable time entries can become, for example, a line item on the client's statement or invoice.

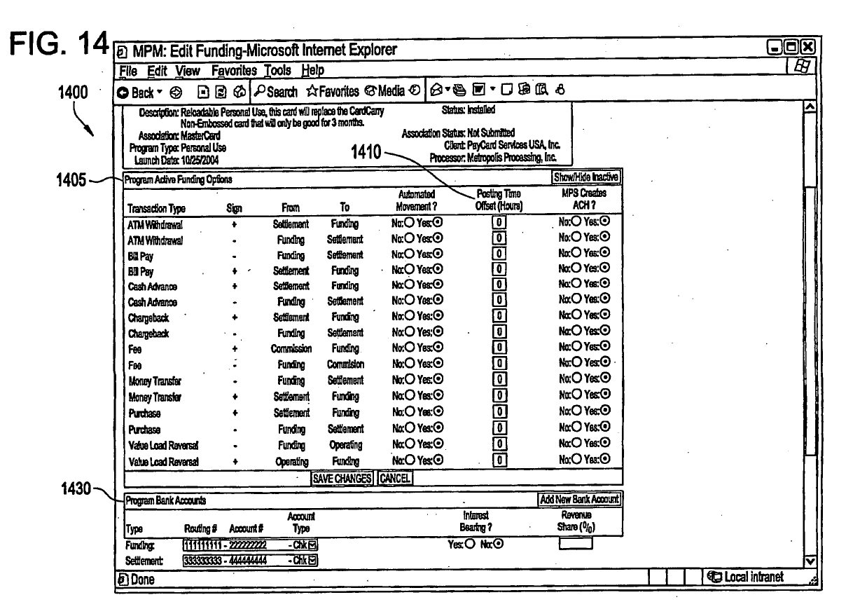

Also under the “Programs” tab 1010 in the top-level menu 730, FIG. 14 illustrates a program funding page 1400, in accordance with an exemplary embodiment of the present invention. The funding page 1400 can be accessed by, for example, selecting the “Programs” tab 1010 in the top-level menu 730 and the “Funding” tab in the corresponding sub-menu 1005. The program funding options 1405 on the program funding page 1400 can display the date that the system 100 will need to automatically generate the ACH funding for the program. For example, every posted transaction that is on the posted report 300 of the card processor 110 can be stamped with a transaction type. When purchase funding is turned on, ACH records can be created each day (or suitably periodically) to move the funds at a program level from settlement to funding or funding to settlement based on the transaction sign. For example, a posting time offset 1410 can inform the system 100 to adjust the time of the transaction by a number of hours (or other appropriate time period) so that the transaction can roll up to the appropriate business day. Other like information can be displayed on the program funding page 1400. For example, FSA benchmark parameters can include benchmark values and funding percent that can be used to maintain the appropriate funding in the account. The benchmark value can be increased automatically when more value is loaded to the program. The funds can be replenished periodically (e.g., daily) based on purchases. Bank accounts 1430 can be assigned for each type of funds movement that is going to occur in the finding options 1405 section.

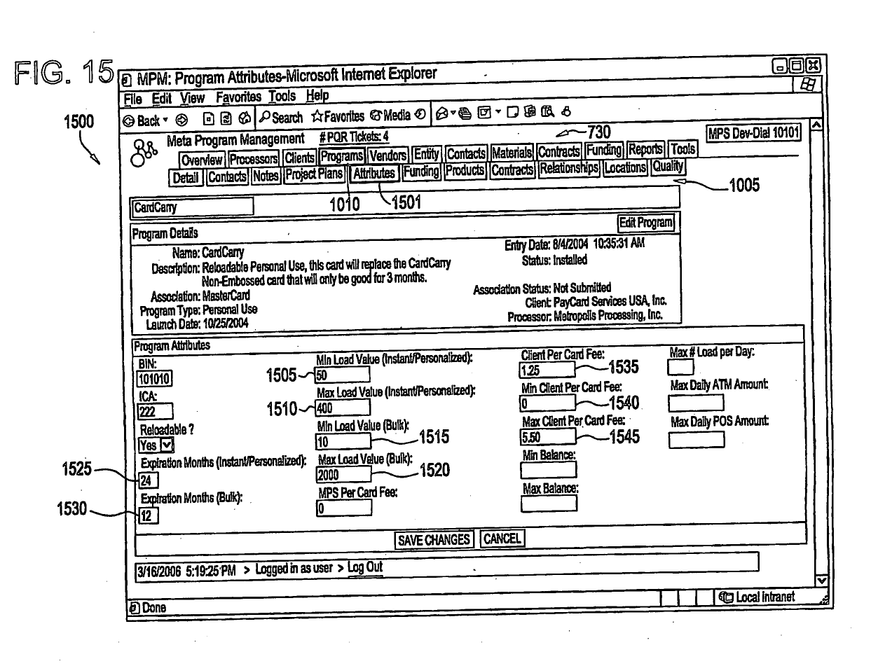

Further under the “Programs” tab 1010 in the top-level menu 730, FIG. 15 illustrates a program attributes page 1500, in accordance with an exemplary embodiment of the present invention. The program attributes page 1500 can be accessed by, for example, selecting the “Programs” tab 1010 in the top-level menu 730 and the “Attributes” tab 1501 in the corresponding sub-menu 1005. The program attributes page 1500 can allow administrators to set values that can be used to manage the functionality of the program. For example, an administrator can use such values to enforce restrictions on the card products, including, for example, the minimum load amount (e.g., minimum load amount 1505 for instant/personalized orders, minimum load amount 1515 for bulk orders), the maximum load amount (e.g., maximum load amount 1510 for instant/personalized orders, maximum load amount 1520 for bulk orders), expiration date (e.g., expiration date 1525 for instant/personalized orders, expiration date 1530 for bulk orders), client fees 1535 per card product (including, for example, minimum and maximum client fees per card product 1540 and 1545, respectively), and other like attributes.

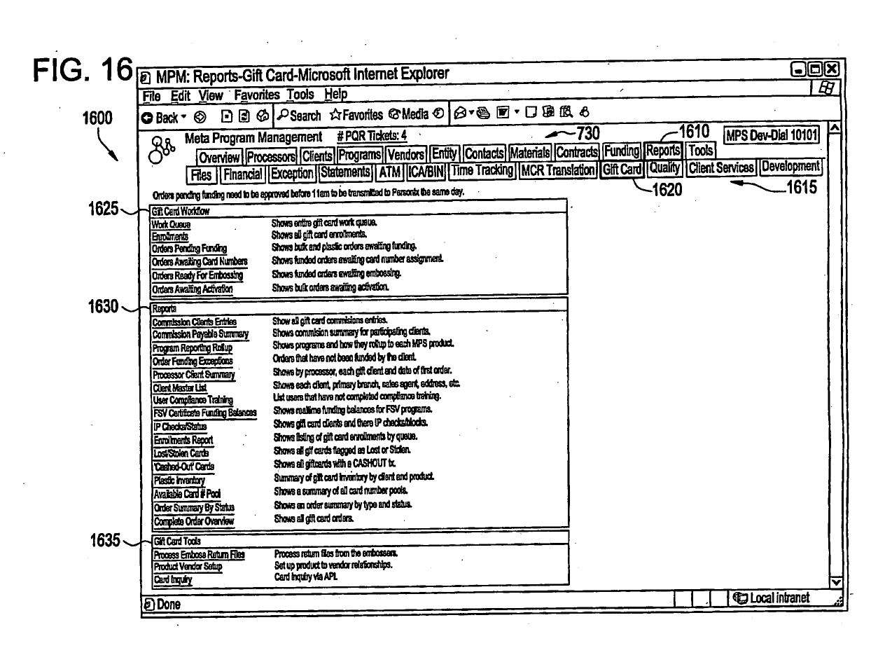

The management application server module 125 is configured to display various suitable types of reports to an administrator or other appropriate users. FIG. 16 illustrates a gift card report page 1600, in accordance with an exemplary embodiment of the present invention. By selecting the “Reports” tab 1610 in the top-level menu 730, the administrator can be presented with an appropriate sub-menu 1615 of report options for the given tab. For example, for the “Reports” tab 1610, the corresponding sub-menu 1615 can include such additional tabs as “Files,” “Financial,” “Exception,” “Statements,” “Time Tracking,” “NCR Translation,” “Gift Card,” “Quality,” “Client Services,” “Development” and other like reports. For purposes of illustration and not limitation, by selecting the gift card tab 1620 of the sub-menu 1615, the administrator can view or generate various types of reports for gift cards (or other card products) and supporting tools, including, for example, gift card workflow 1625 (e.g., work queues, enrollments, orders pending funding, orders awaiting card numbers, orders ready for embossing, orders awaiting activation and the like), reports 1630 (e.g., commission client entries, commission payable summary, program reporting rollup, order funding exceptions, processor client summary, client master list, plastic inventory, lost/stolen cards, “cashed-out” cards, complete order overview, available card number pool, order summary by status and other like reports) and gift card tools 1635 (e.g., card inquiry and the like). For example, a gift card order summary report page can display a summarized listing (e.g., by day, week, month or the like) of any or all gift card orders, including such information as order number, date of order, type of order, status of order, client, quantity, total load amount, plastic fees, adjustments, total amount, and other like information.

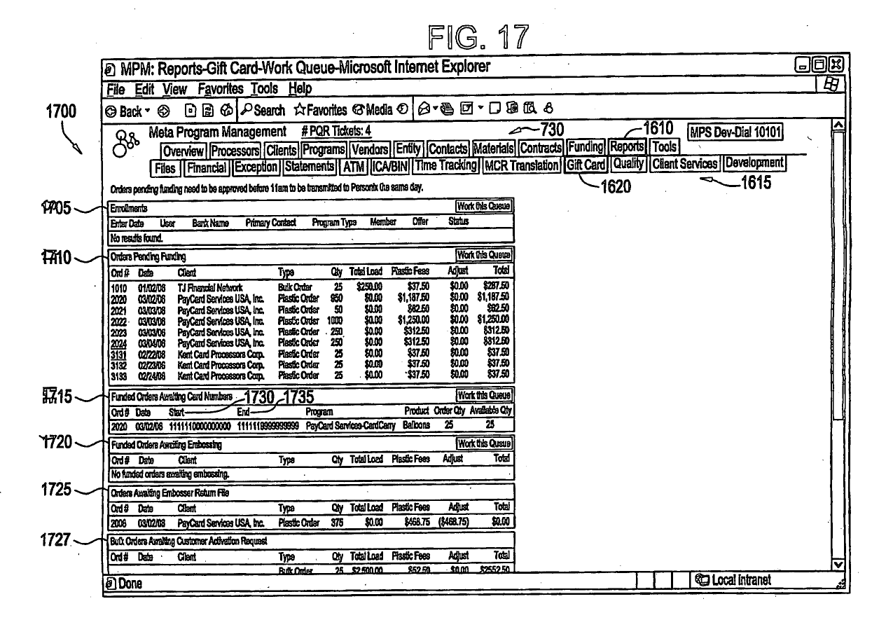

Continuing with the present illustration, with respect to the exemplary types of reports that can be viewed for gift cards (or other card product products) from gift card report page 1600, FIG. 17 illustrates a work queue report page 1700 selected from the list of the gift card workflow 1625, in accordance with an exemplary embodiment of the present invention. An administrator can use the work queue report page 1700 to, for example, approve, decline, move and monitor enrollments, bulk and plastic orders and the like for, for example, a gift card or other suitable card product program. Some of the types of information that can be viewed on the work queue report page 1700 includes enrollments 1705. For example, online enrollments can be completed by sales agents for each new card product client, which can initiate the appropriate contract, due diligence and program setup by the card product management system 100. Orders pending funding 1710 can display those orders that need funding verified and/or approved. Funded orders awaiting card numbers 1715 can present a list of orders that require card numbers created and assigned (e.g., in the manner described previously for allocating and assigning card numbers). Funded orders awaiting embossing 1720 includes a display of orders that need to be sent to an embosser. Orders awaiting embosser return file 1725 can list the orders at the embosser that require a result file or the like to be processed. Other suitable information can be displayed on the work queue report page 1700, including, for example, bulk orders awaiting customer activation request 1727 (e.g., a list of orders in route to the customer that are waiting for the customer to initiate the activation and load of the card product), orders awaiting activation by the system 100 (e.g., a list of orders that have been received from the customer and the customer has requested activation and load of the card product), and other like information. It is also noted that a range of available card numbers according to exemplary embodiments can be displayed in the funded orders awaiting card numbers 1715, for example, providing the start 1730 and end 1735 card numbers (e.g., where the first six digits of a card product number comprises a BIN, and the remaining ten digits—0000000000 to 9999999999—are available for card number allocation).

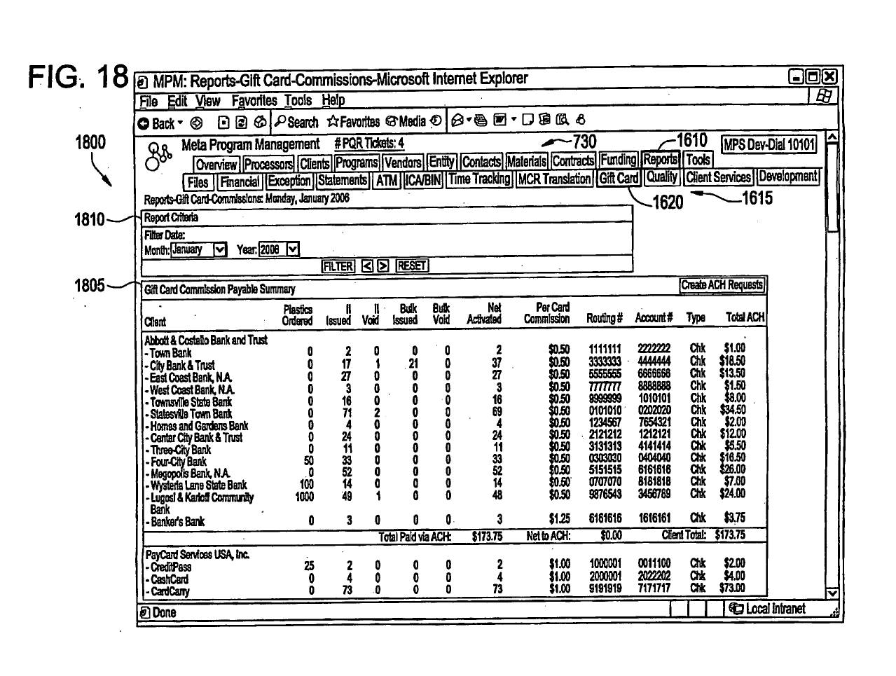

FIG. 18 illustrates a commission payable summary report page 1800, in accordance with an exemplary embodiment of the present invention. The commission payable summary report page 1800 can be accessed from the reports 1630 section of the gift card report page 1600. For example, gift card commission payable summary 1805 can display and track any or all commissions paid at the order type level or the like. According to an exemplary embodiment, a commission entry can be automatically generated for the sales agent when an enrollment is approved by the system 100. Commissions can be sent via ACH or other suitable means for electronic funds transfer to the sales agent. The administrator can filter the information displayed on the gift card commission payable summary 1805 by entering appropriate report criteria in the report filter criteria section 1810 to view any suitable additional or alternative subset of the gift card commission payable summary 1805.

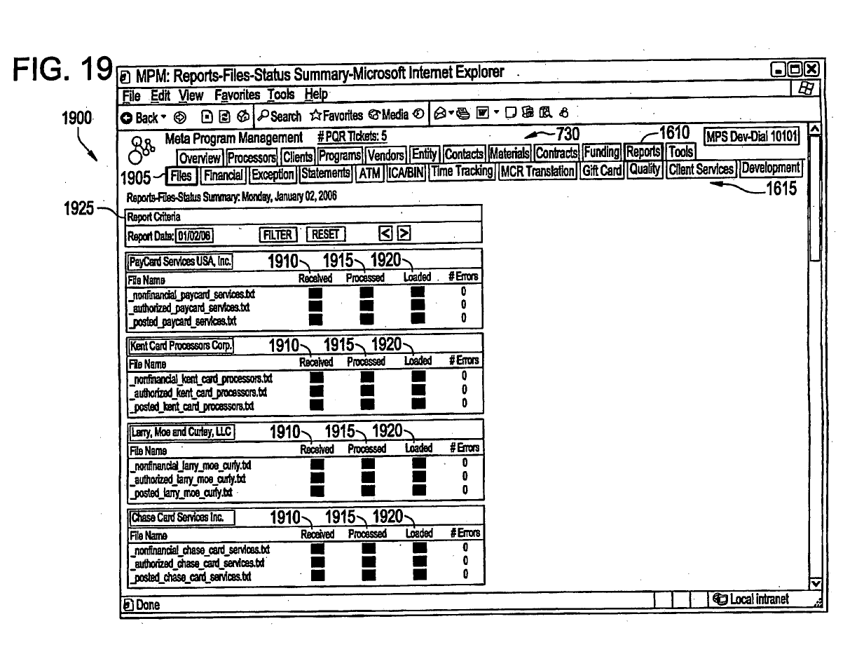

Other reports can be generated and viewed by selecting the appropriate tab or menu item of the “Reports” tab 1610, such as a listing of “Files.” For example, FIG. 19 illustrates a report files page 1900, in accordance with an exemplary embodiment of the present invention. The report files page 1900 is accessed by selecting the files tab 1905. As discussed previously, the system 100 can receive any suitable number of reports from each card processor 110, including, but not limited to, for example, a general or non-financial report 200, a posted report 300 and an authorization report 400. Such data can be loaded into a central repository (e.g., database module 120) and each transaction listed in the reports can be stamped with a common transaction code and product type defined by the system 100. The status of each report file can be monitored during the load process using the report files page 1900. For each card processor 110, the report files page 1900 can list whether each of the general report 200, posted report 300 and authorization report 400 was received 1910, processed 1915 and/or loaded 1920. As noted above, data in the reports can be validated against, for example, a translation matrix for each card processor 110 that is defined by the card processor 110 and system 100 during the processor setup. Any errors found in any of the reports can be researched and corrected before the data is accepted. Once all of the data is successfully loaded into the database module 120, the system 100 can initiate ACH requests or other similar funds transfer procedures for periodic (e.g., daily) funds movement. The administrator can filter the information displayed on the report files page 1900 by entering appropriate report criteria in the report filter criteria section 1925 to view any suitable additional or alternative subset of the report files information. Thus, the card product management system 100 can report collected data across any combination of programs, clients, processors, associations, transaction types and the like.

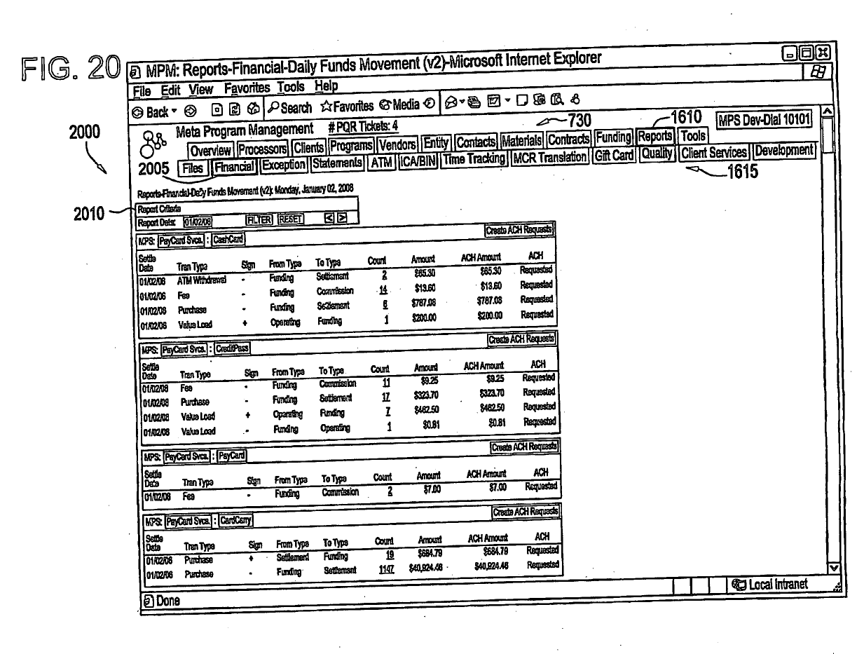

To monitor funds movement, the administrator can select a “Financial” tab under the “Reports” tab 1610. FIG. 20 illustrates a financial report page 2000, in accordance with an exemplary embodiment of the present invention. The financial report page 2000 is accessed by selecting the financial tab 2005 in the sub-menu 1615. Funds movement can be based on funding rules defined at the time of program setup and the periodic (e.g., daily) transaction data. ACH requests or other suitable funds transfer requests can be based on, for example, aggregate money movements for each program by transaction type and sign. The management application server module 125 can reconcile requested ACH amounts against calculated amounts and report discrepancies. Additionally, the management application server module 125 is configured to recognize pre- and post-dated transactions, and can initiate ACH requests or other suitable funds transfer requests accordingly. Thus, the financial report page 2000 can display information to the administrator or other appropriate user for each card processor 110, such as, for example, settlement date, transaction type, sign of the transaction (e.g., indicating credit or debit), the type of accounts from and to funds will be transferred, amount of the transfer, ACH amount, status of transfer and other suitable information. The administrator can filter the information displayed on the financial report page 2000 by entering appropriate report criteria in the report filter criteria section 2010 to view any suitable additional or alternative subset of the financial information.

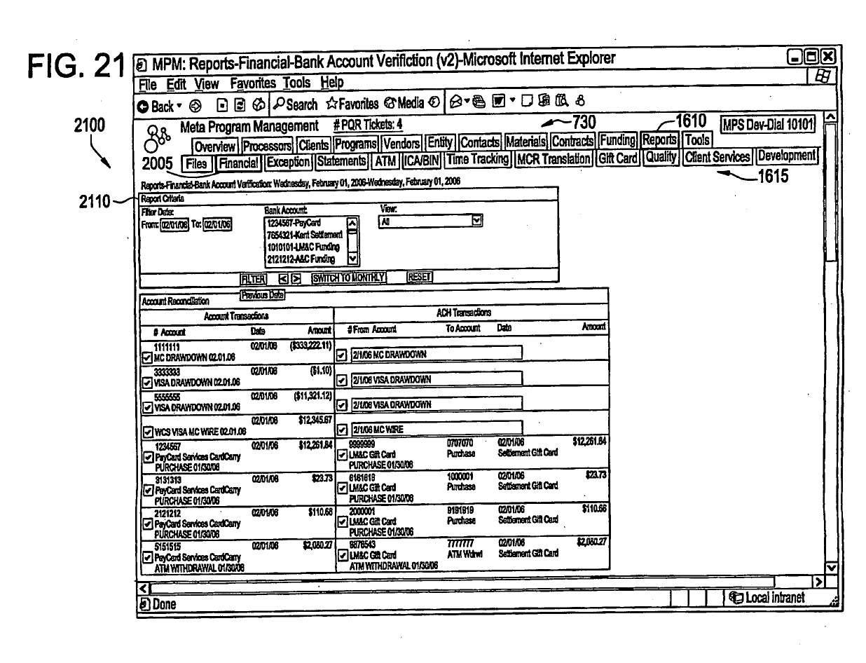

Additionally, the financial report page 2000 can display a listing of account reconciliations and other similar information. FIG. 21 illustrates an account reconciliation report page 2100, in accordance with an exemplary embodiment of the present invention. Periodically (e.g., each day), the system 100 can load daily or periodic GL (General Ledger) and DDA (Demand Deposit Account) account activity and other suitable information. The management application server module 125 is configured to systematically reconcile each transaction against the original ACH request created by the daily or periodic funds movement process. The administrator can review such information and make manual reconciliation entries where necessary, and systemic entries can be edited by the administrator, if necessary. Again, the administrator can filter the information displayed on the account reconciliation page 2100 by entering appropriate report criteria in the report filter criteria section 2110 to view any suitable additional or alternative subset of the account reconciliation information.

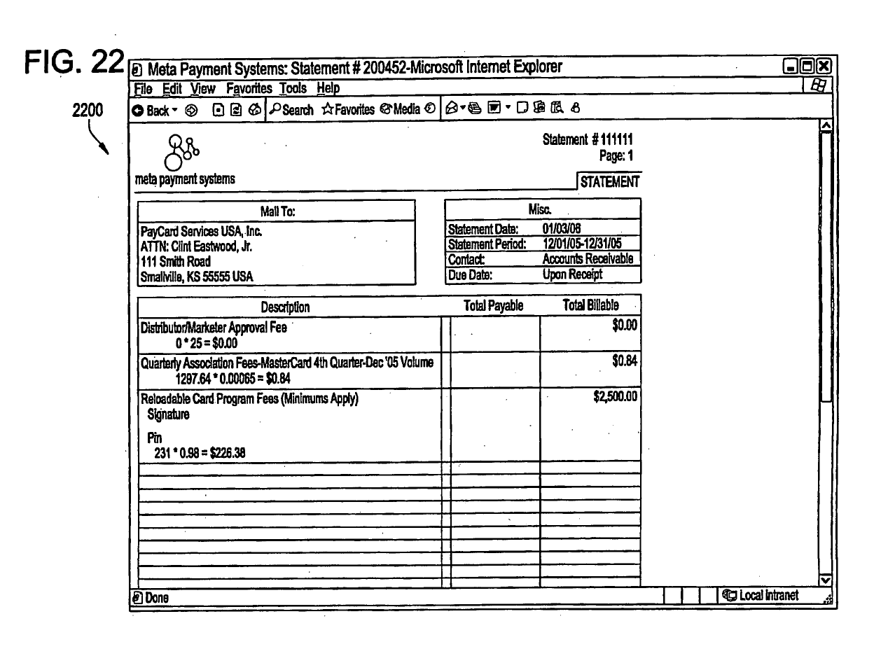

For each card processor 110 or other client, customer or user, the card product management system 100 can generate appropriate statements or invoices for card products purchased using the system 100. FIG. 22 illustrates a statement 2200 generated by the card product management system 100, in accordance with an exemplary embodiment of the present invention. The statements 2200 can be generated automatically based on statement definitions. Such statements 2200 can be in draft mode until all or substantially all data is complete. Any statement data that cannot be automatically created can put the statement into a “pending approval” status or the like, and the administrator can manually enter any such statement data that could not be automatically created. The statement 2200 can provide the client with a suitable listing or invoice of purchases requiring payment by the client, including a breakdown of individual purchases and purchase totals, and total amounts owed.

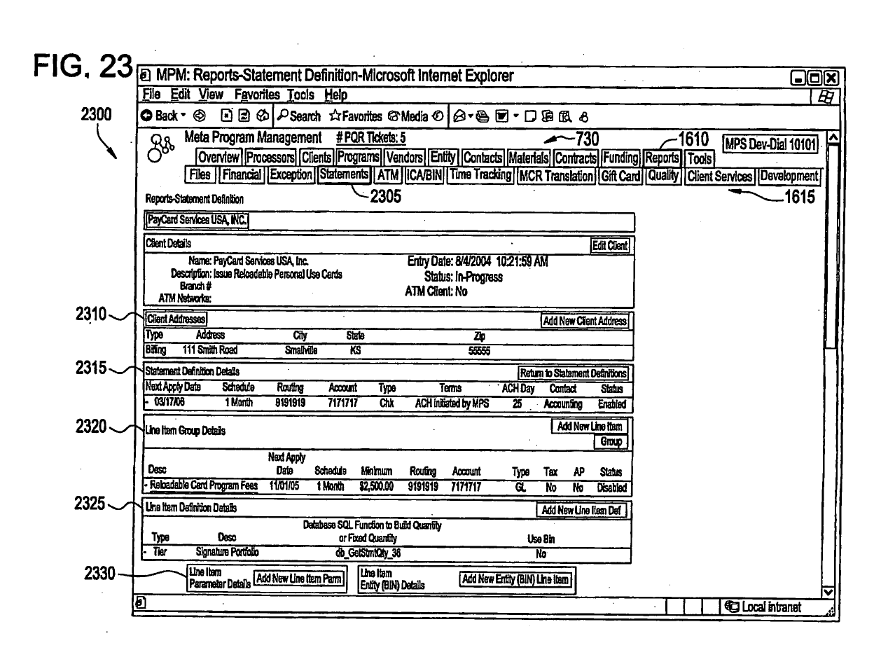

As discussed previously, the statements 2200 can be generated based on statement definitions. FIG. 23 illustrates a statement definition report page 2300, in accordance with an exemplary embodiment of the present invention. The statement definition report page 2300 can be accessed by selecting, for example, the statement tab 2305 in the sub-menu 1615 under the “Reports” tab 1610 in the top-level menu 730. Statement definitions can be set up based on the rules specified in, for example, the contract or other binding agreement with the card processor 110. The statement (e.g., statement 2200) can be created on the appropriate day and/or time based on the schedule established in the contract. The management application server module 125 can be configured to limit the changes that can occur to a definition once a statement has been created (e.g., through appropriate rules, restrictions and security features). In addition, the management application server module 125 is configured to allow the administrator to manually add one-time entries to a statement. The statement definition report page 2300 can include any suitable information for generating statements, such as, for example, client details (e.g., client addresses 2310), statement definition details 2315, line item group details 2320, line item definition details 2325, line item parameter details 2330 and other like information.

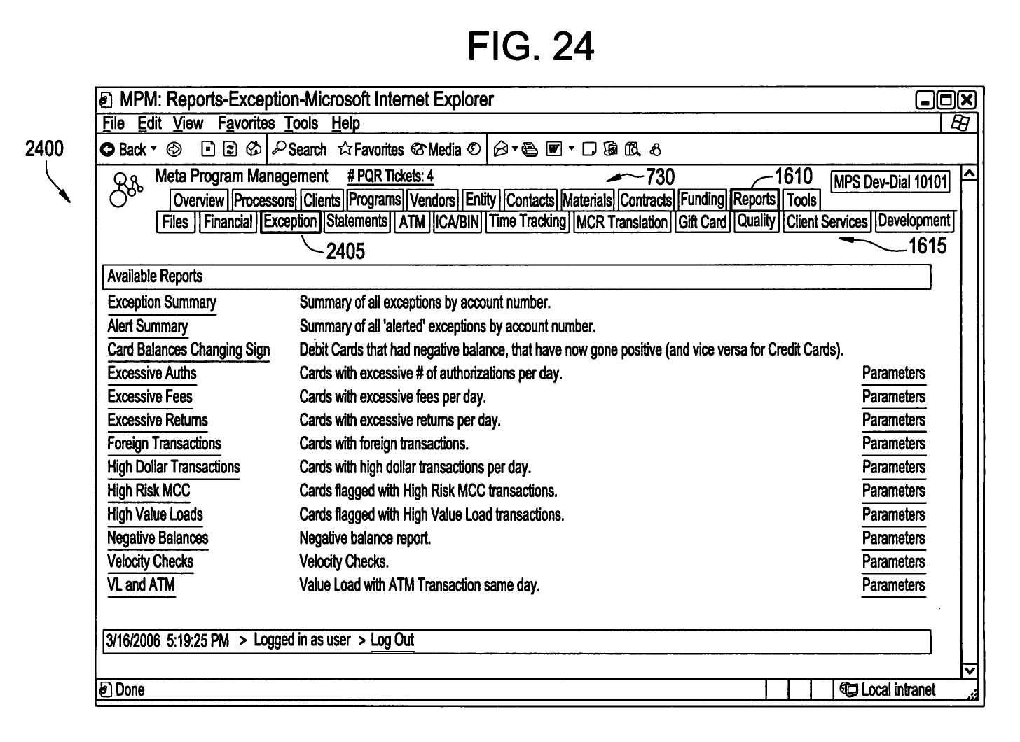

The management application server module 125 is also configured to provide extensive exception reporting tools. FIG. 24 illustrates an exception report page 2400, in accordance with an exemplary embodiment of the present invention. The exception report page 2400 can be accessed by selecting, for example, the exception tab 2405 in the sub-menu 1615 under the “Reports” tab 1610 of the top-level menu 730. According to an exemplary embodiment, on a periodic basis, card-product-level exceptions can be reported using appropriate screening filters (e.g., based on pre-defined rules or other suitable filtering or screening parameters). Examples of such available exception reports include, for example: “Generate Exceptions” (e.g., flag exceptions to generate for a given date); “Exception Summary” (e.g., a summary of any or all exceptions by card or account number); “Card Balance Changing Sign” (e.g., debit cards and the like that had a negative balance, and that have now gone positive, and vice versa for credit cards and the like); “Credit Balances”; “Excessive Authorizations” (e.g., card products with an excessive number of authorizations per day); “Excessive Fees” (e.g., card products with excessive fees per day); “Excessive Returns” (e.g., card products with excessive returns per day); “Foreign Transactions” (e.g., card products with foreign transactions); “High Dollar Transactions” (e.g., card products with high dollar transactions per day); “High Risk MCC” (e.g., card products flagged with high risk MCC transactions); “High Value Loads” (e.g., card products flagged with high value load transactions; “Negative Balances”; “Negative Balances (30 Days)”; “Negative Balances (60 Days)”; “Negative Balances (90 Days)” “Out of Balance”; “Velocity Checks”; and any other suitable exception reports. By selecting any one of these entries, the administrator can view the details of the chosen exception report.

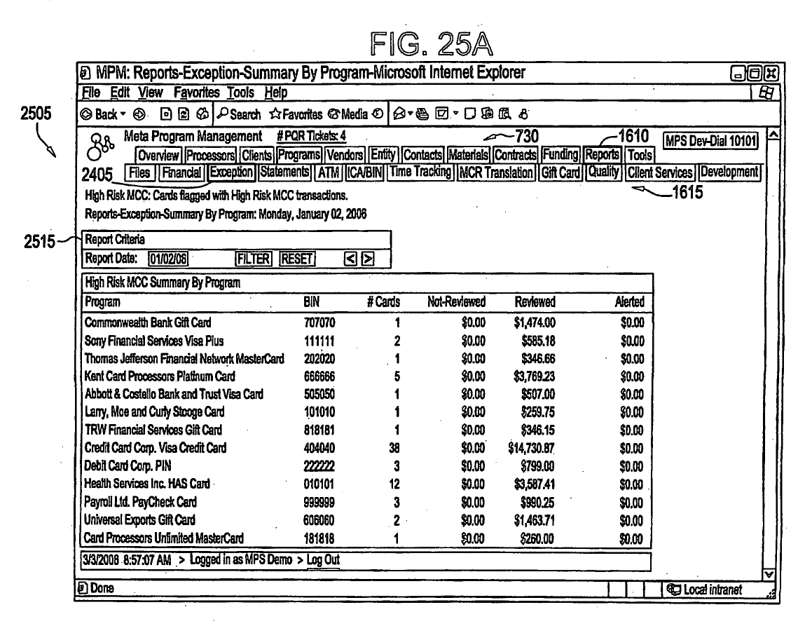

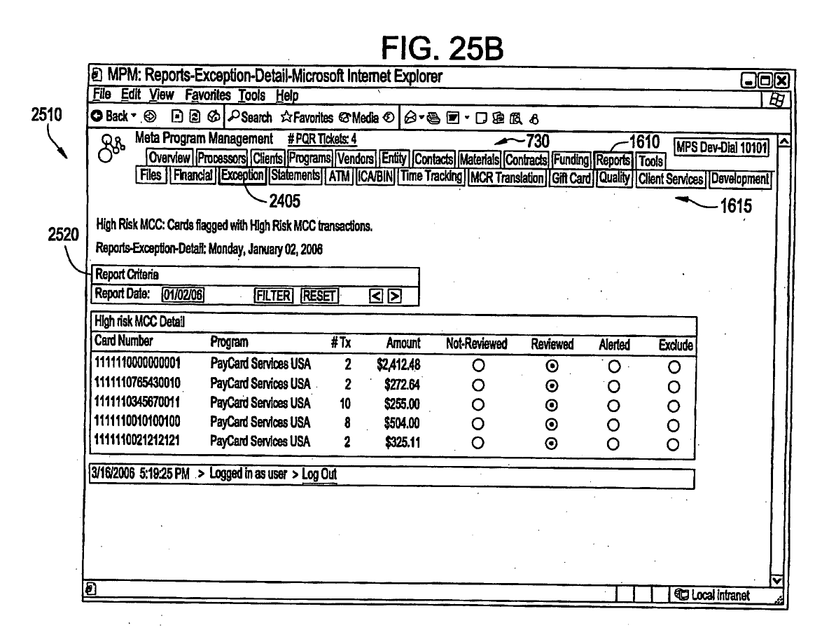

For example, FIGS. 25A and 25B illustrate exception detail report pages, in accordance with an exemplary embodiment of the present invention. As illustrated in FIG. 25A, high risk MCC summary page 2505 can list a summary of cards flagged with high risk MCC transactions by program, including such items as the program name, BIN, number of accounts, and dollar amounts of transaction not reviewed, reviewed and alerted, as well as other suitable summary information. As illustrated in FIG. 25B, high risk MCC detail page 2510 can present a display of the details of card products with high risk MCC transactions for the day by program, including items similar to or different than those listed in the high risk MCC summary page 2505. The exceptions can be built from the daily or periodic transaction detail that can be provided in the reports (e.g., general report 200, posted report 300 and authorization report 400 or any other suitable report(s)) received from the card processors 110. The exceptions can be marked as, for example, not-reviewed, reviewed or alerted, as illustrated in the exemplary exception detail report pages of FIGS. 25A and 25B. An exception history can be maintained (e.g., in database module 120) for research and reporting purposes. As with other reporting pages, the administrator can filter the information displayed on the exception reporting pages by entering appropriate report criteria in the respective report filter criteria sections (e.g., section 2515 of the high risk MCC summary page 2505 and/or section 2520 of the high risk MCC detail page 2510) to view any suitable additional or alternative subset of the detailed exception information.

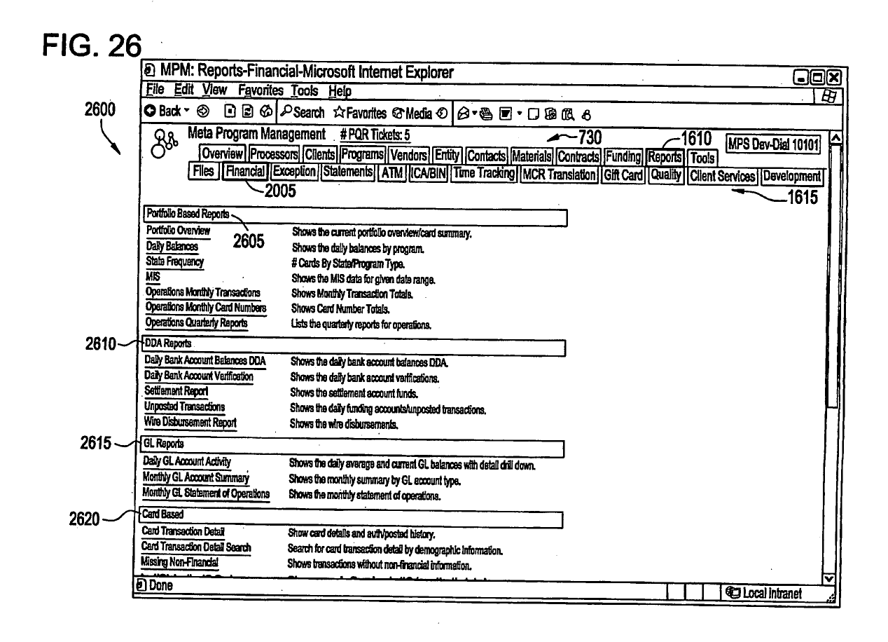

The management application server module 125 can provide the administrator or other appropriate user with any other suitable financial report based on information associated with the card products. For example, FIG. 26 illustrates a financial reports page 2600, in accordance with an exemplary embodiment of the present invention. The financial reports page 2600 can be reached by selecting, for example, the “Financial” tab 2005 in the sub-menu 1615 under the “Reports” tab 1610 of the top-level menu 730. As illustrated in FIG. 26, the financial reports can be grouped as, for example, portfolio based reports 2605, DDA reports 2610, GL reports 2615 and card-based reports 2620. Examples of available financial reports include, for example: “Daily Balances” (e.g., daily balances by program); “Daily Bank Account Balances DDA”; “Daily Bank Account Balances GL (Confidential)”; “Daily Bank Account Reconciliations”; “Unposted Transactions” (e.g., daily finding accounts/unposted transactions); “Settlement Report” (e.g., settlement account funds); “Portfolio Overview” (e.g., current portfolio overview/card summary); “0/30+ Days Negative Balances”; “Daily Funds Movement” (e.g., daily finds movement by program with card product aggregate); “MIS” (e.g., MIS data for a given date range); “State Frequency” (e.g., number of cards by state/program type); “Missing Non-Financial” (e.g., transactions without non-financial information); “Lost/Stolen (Last 7 Days)” (e.g., cards flagged as lost/stolen within the last seven days); “Card Transaction Detail” (e.g., card details and authorization/posted history); “Gift Card Program Summary”; “Gift Card ACH Funding” (e.g., daily card product funding); “ACH File Log” (e.g., client ACH files/audit trail); “ACH Queue” (ACH requests/queue); and any other suitable financial reports. By selecting any one of these entries under the appropriate report group, the administrator can view the details of the chosen financial report. Any or all of the financial reports can have date range and other report-specific filters so that the data can be generated at a point in time in many different views. To generate such financial reports, the database (e.g., database module 120) can be built from the daily or periodic report files (e.g., general report 200, posted report 300 and authorization report 400) from the card processors 110. Any suitable types, ordering, grouping and other like characteristics of the financial reports can be displayed and available to a user through the financial reports page 2600.

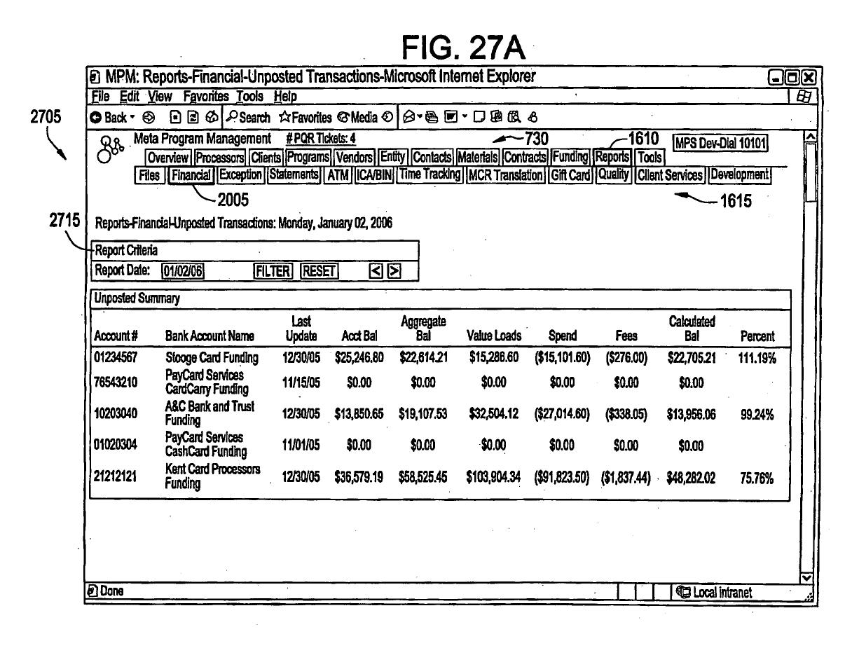

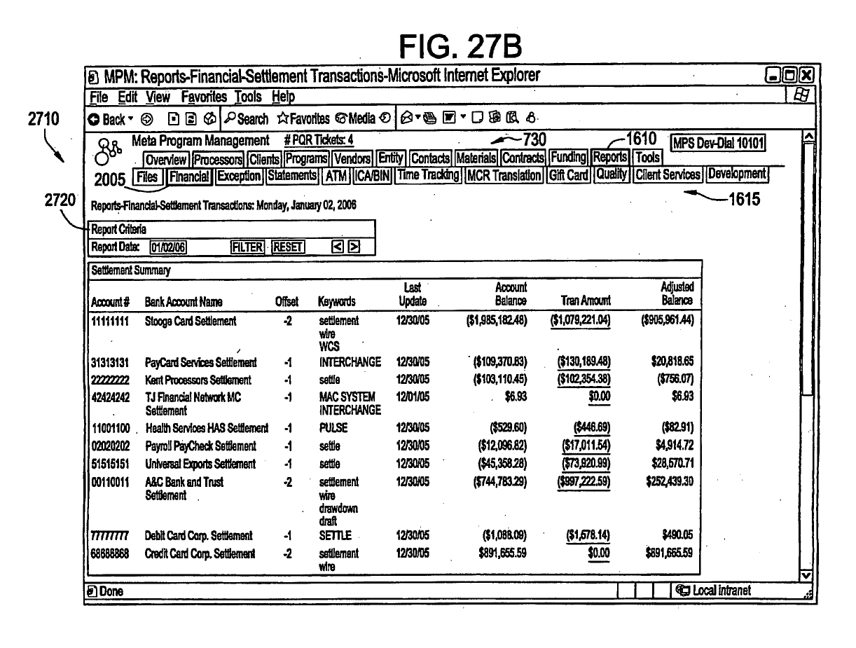

FIGS. 27A and 27B illustrate financial report pages, in accordance with an exemplary embodiment of the present invention. As illustrated in FIG. 27A, unposted summary page 2705 can list the daily funding accounts and unposted transactions. For example, the management application server module 125 can take the aggregate card balance minus value loads, and subtract the spending and cardholders fees for the previous two or four days (or any suitable time frame) to generate a calculated balance, which should be less than the funding account balance also listed in the unposted summary page 2705. As illustrated in FIG. 27B, settlement summary page 2710 can display settlement account funds. For example, the management application server module 125 can take the settlement account balance for the selected time period (e.g., day) and add in the settlement paid out for the previous two days to generate an adjusted balance. As with other displayed pages, the administrator can filter the information displayed on the financial reporting pages by entering appropriate report criteria in the respective report filter criteria sections (e.g., section 2715 of the unposted summary page 2705 and/or section 2720 of the settlement summary page 2710) to view any suitable additional or alternative subset of the detailed financial information.

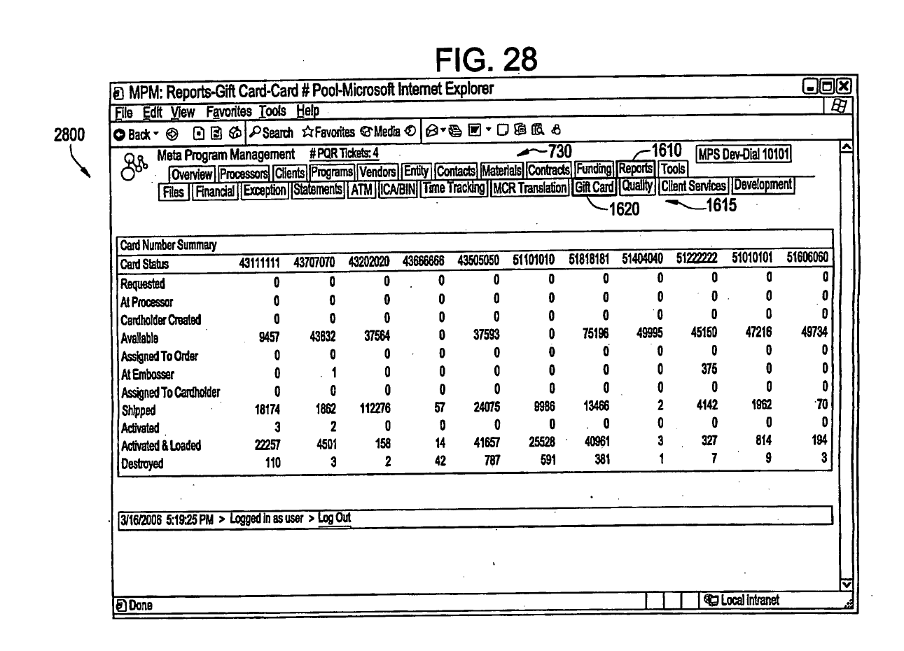

The management application server module 125 can display any other suitable reports or information through the associated GUI. As discussed previously, the client application server module 115 can be configured to allocate and assign card numbers corresponding to each BIN (or other unique identifier) for the card products. According to exemplary embodiments, the system 100 can be configured to display a summary (e.g., a distribution summary) of card numbers for each BIN through a GUI, such as the GUI used for the management application server module 125. For example, FIG. 28 illustrates a card number summary page 2800, in accordance with an exemplary embodiment of the present invention. The card number summary page 2800 can be reached by selecting, for example, the “Gift Card” (or suitable “Card product”) tab 1620 in the sub-menu 1615 under the “Reports” tab 1610 in the top-level menu 730. For example, the card number summary page 2800 can display the count of “Available” card number per BIN (e.g., where, merely for purposes of illustration, the last six digits of each of the numbers listed in the “Card Status” row can comprise a BIN or other unique identifier). Other suitable card number summary information can be displayed to the user in the card number summary page 2800, including, for example, the count of “Shipped,” “Activated,” “Activated & Loaded” and “Destroyed” cards and/or card numbers per BIN and other like information. In addition, the system 100 can be configured to display a list of available card numbers for each BIN through the GUI to manage the card products across card processors 110, although such a feature can be disabled by the system 100 for purposes of security when appropriate.

Although the card product management system 100 can be used to manage information associated with cards and card products, the system 100 can be used to manage financial information and conduct suitable types of financial transactions, such as, for example, money transmittals or transfers and the like, either with or without the use of an accompanying card product. For example, a local user can request that a local financial institution (e.g., a bank) transfer or otherwise transmit a sum of money to an individual in a remote location (e.g., another bank or outlet in another country) using the system 100. The local financial institution can access the system 100 to perform the monetary transfer (e.g., transfer the money from one user account to another, from one card processor 110 to another, from one financial institution to another, or other like transaction). The individual in the remote location can then go to the remote bank that received the monetary transfer, and present appropriate identification to the remote bank. The identity of the individual can be verified by the remote bank using the system 100 (e.g., the name, address and, for example, a personal identification number (PIN) can correspond to records maintained in the system 100 for the money transmittal). Once verified, the individual can be given the transferred money. The card product management system 100 can be used for other such financial transactions, such as, for example, “pay pass” accounts, biometric accounts and the like, either with or without the use of a card or card product.

The card product management system 100 is configured to be compliant with all applicable federal and state laws and regulations, including state laws restricting fees and expiration dates, state disclosure laws, state laws requiring small balance refunds at the point of sale, state money transmitter licensing laws, state abandoned property laws, and the like.

Each of modules of card product management system 100, including agent portal module 105, client application server module 115, management application server module 125, and graphical user interface module 130, or any combination thereof, can be comprised of any suitable type of electrical or electronic component or device that is capable of performing the functions associated with the respective element. According to such an exemplary embodiment, each component or device can be in communication with another component or device using any appropriate type of electrical connection that is capable of carrying electrical information. Alternatively, each of the modules of card product management system 100 can be comprised of any combination of hardware, firmware and software that is capable of performing the functions associated with the respective module.

Alternatively, the card product management system 100 can be comprised of one or more microprocessors and associated memory(ies) that store the steps of a computer program to perform the functions of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming. For example, the actual source code or object code of the computer program can be stored in the memory. For example, according to an exemplary embodiment, the agent portal module 105 and the management application server module 125 can each be implemented using a WINDOWS™ server (e.g., WINDOWS™ 2003 or XP server) running on a suitable-equipped PC, or other similar computer architecture or computer systems (e.g., HEWLETT-PACKARD™ servers). According to an exemplary embodiment, the database module 120 can be implemented using a SQL server and corresponding SQL database.

The card product management system 100 can include other suitable modules and components (whether implemented in hardware, software, firmware or any combination thereof) for use in managing the system 100, including log modules, error modules, security modules, and the like. For example, the system 100 can include a suitable first firewall 150 located between the card processors 110 and the agent portal module 105 to prevent any malicious intrusion into or computer attacks on the system 100. A suitable second firewall 155 can be located between the agent portal module 105 and the combination of the database module 120 and management application server module 125 to prevent unrestricted user access to the management application server module 125 and to the information stored and maintained in the storage module 120.

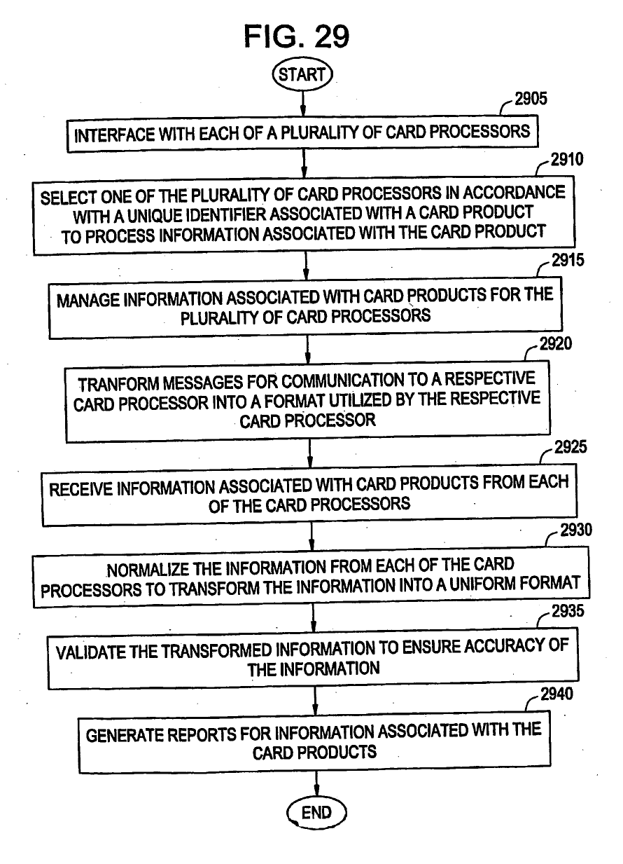

FIG. 29 is a flowchart illustrating steps for managing card product information, in accordance with an exemplary embodiment of the present invention. Each of a plurality of card processors are interfaced to in step 2905. In step 2910, one of the plurality of card processors is selected in accordance with a unique identifier associated with a card product to process information associated with the card product. In step 2915, information associated with card products is managed for the plurality of card processors. In step 2920, messages for communication to a respective card processor are transformed into a format utilized by the respective card processor. In step 2925, information associated with card products is received from each of the card processors. According to an exemplary embodiment, the information from each card processor comprises a plurality of reports. For example, the plurality of reports can include at least one of a general report, a posted report and an authorization report. In step 2930, the information from each of the card processors is normalized to transform the information into a uniform format. In step 2935, the transformed information is validated to ensure accuracy of the information. In step 2940, reports can be generated for information associated with the card products. For example, each report can be populated with information in accordance with an identification of a user.

In addition, according to exemplary embodiments, information associated with card products can be stored. Users can be provided access to manage information associated with card products. For example, a graphical user interface can be displayed through which users access information associated with card products. According to an exemplary embodiment, access can be granted to a user through the graphical user interface using a password and an associated computer network address of the user. Once granted access, products can be presented or otherwise displayed to a user through the graphical user interface in accordance with at least one of a user identification and an association with a financial institution. For example, a theme of the graphical user interface can be associated with each card processor. Each card processor can be presented with the theme associated with the card processor when interacting through the graphical user interface.

According to an exemplary embodiment of the present invention, the card processors are configured to associate corresponding BINs to the card products. Card numbers can be allocated corresponding to each BIN for the card products. A summary of card numbers for each BIN can be displayed. Each card product can comprise a card product number. The card product number can comprise a first portion of digits and a second portion of digits. The first portion of digits comprises a BIN. The card processors are configured to associate BINs to the card products. Card numbers can then be allocated to substantially all of the second portion of digits for each BIN.

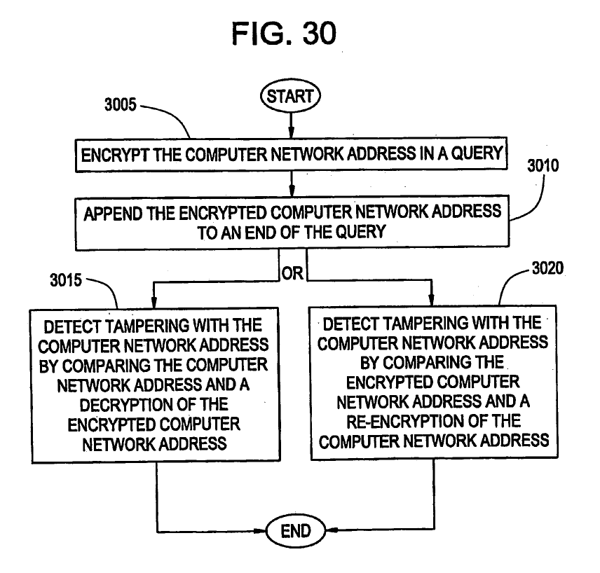

FIG. 30 is a flowchart illustrating steps for detecting tampering with information communicated to a card processor, in accordance with an exemplary embodiment of the present invention. Messages to the card processors can include a query comprising a computer network address of a file or the like. In step 3005, the computer network address can be encrypted. For example, a cryptographic hash function or other like encryption technique can be used to encrypt the computer network address. In step 3010, the encrypted computer network address can be appended to an end of the query. In step 3015, tampering with the computer network address can be detected by comparing the computer network address and a decryption of the encrypted computer network address. Alternatively, in step 3020, tampering with the computer network address can be detected by comparing the encrypted computer network address and a re-encryption of the computer network address.

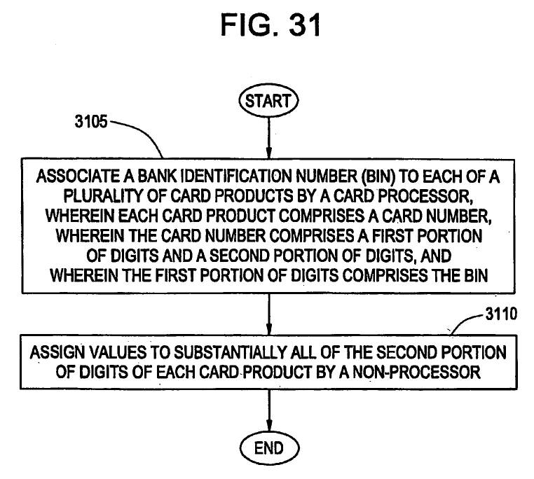

FIG. 31 is a flowchart illustrating steps for processing card products, in accordance with an exemplary embodiment of the present invention. In step 3105, a BIN can be associated to each of a plurality of card products by a card processor. Each card product can comprise a card product number. The card product number can comprise a first portion of digits and a second portion of digits. The first portion of digits can comprise the BIN. In step 3110, values can be assigned to substantially all of the second portion of digits of each card product by a non-processor. The non-processor is configured to manage information associated with the plurality of card products. The values assigned to substantially all of the second portion of digits of each card product can comprise a card number. Card numbers can be allocated for each BIN by the non-processor. For example, card numbers can be allocated sequentially for each BIN. Alternatively, card numbers can be allocated randomly for each BIN. The values assigned to substantially all of the second portion of digits of each card product can correspond to separate users.

Any or all of the steps of a computer program as illustrated in FIGS. 29-31 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system, process or transaction that processes card product information. Exemplary embodiments can be used by financial institutions as part of reloadable or non-reloadable card product programs to access, administer and manage the information associated with the card products or to perform other suitable types of financial transactions, either with or without the use of the associated card products.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

What is claimed is:

1. An information management system, comprising:
a computer server,
wherein the computer server includes an interface module; and
a plurality of card processors in communication with the computer server via the interface module,
wherein the computer server is configured to interface with each of the plurality of card processors via the interface module, and
wherein the computer server is configured to choose one of the plurality of card processors in accordance with a unique identifier associated with a card product to process information associated with the card product.

2. The information management system of claim 1, wherein the interface module is configured to transform messages for communication to a respective card processor into a format utilized by the respective card processor.

3. The information management system of claim 1, comprising:
a database in communication with the computer server,
wherein the database module is configured to store information associated with card products.

4. The information management system of claim 3, comprising:
a management module in communication with the database,
wherein the management module is configured to manage the information management system.

5. The information management system of claim 1, wherein each card product comprises a card number,
wherein the card number comprises a first portion of digits and a second portion of digits,
wherein the first portion of digits comprises a bank identification number (BIN),
wherein the card processors are configured to associate BINs to the card products, and
wherein the computer server is configured to allocate card numbers to substantially all of the second portion of digits for each BIN.

6. A card product management system, comprising:
an agent portal module; and
a plurality of card processors in communication with the agent portal module,
wherein the agent portal module is configured to interface with each of the plurality of card processors, and
wherein the agent portal module is configured to choose one of the plurality of card processors in accordance with a unique identifier associated with a card product to process information associated with the card product.

7. The card product management system of claim 6, wherein the agent portal module comprises:
a client application server module.

8. The card product management system of claim 7, wherein the client application server module is configured to transform messages for communication to a respective card processor into a format utilized by the respective card processor.

9. The card product management system of claim 8, wherein messages to the card processors include a query comprising a computer network address of a file, and
wherein an encryption of the computer network address is appended to an end of the query.

10. The card product management system of claim 9, wherein the client application server module is configured to detect tampering with the computer network address by comparing the computer network address and a decryption of the encrypted computer network address.

11. The card product management system of claim 9, wherein the client application server module is configured to detect tampering with the computer network address by comparing the encrypted computer network address and a re-encryption of the computer network address.

12. The card product management system of claim 11, wherein the encryption of the computer network address comprises a cryptographic hash function.

13. The card product management system of claim 7, wherein the client application server module is configured to receive information associated with card products from each of the card processors, and
wherein the information from each of the card processors is normalized to transform the information into a uniform format utilized by the agent portal module.

14. The card product management system of claim 13, wherein the information from each card processor comprises a plurality of reports.

15. The card product management system of claim 14, wherein the plurality of reports comprises at least one of a general report, a posted report and an authorization report.

16. The card product management system of claim 13, wherein the transformed information is validated to ensure accuracy of the information.

17. The card product management system of claim 7, wherein the client application server module is configured to generate reports for information associated with card products.

18. The card product management system of claim 17, wherein each report is populated with information in accordance with an identification of a user.

19. The card product management system of claim 7, comprising:
a database module in communication with the client application server module,
wherein the database module is configured to store information associated with card products.

20. The card product management system of claim 19, comprising:
a management application server module in communication with the database module,
wherein the management application server module is configured to manage the card product management system.

21. The card product management system of claim 19, wherein the agent portal module is configured to allow access by users to manage information associated with the card products.

22. The card product management system of claim 19, wherein the agent portal module comprises:
a graphical user interface module,
wherein the graphical user interface module is configured to display a graphical user interface through which users interact with the card product management system.

23. The card product management system of claim 22, wherein a user is granted access to the card product management system through the graphical user interface using a password and an associated computer network address of the user.

24. The card product management system of claim 22, wherein products are presented to a user through the graphical user interface in accordance with at least one of a user identification and an association with a financial institution.

25. The card product management system of claim 22, wherein a theme of the graphical user interface is associated with each card processor, and
wherein each card processor is presented with the theme associated with the card processor when interacting with the card product management system through the graphical user interface.

26. The card product management system of claim 6, wherein the card processors are configured to associate corresponding bank identification numbers (BINs) to the card products, and
wherein the agent portal module is configured to allocate card numbers corresponding to each BIN for the card products.

27. The card product management system of claim 6, wherein the agent portal module is configured to display a summary of card numbers for each BIN through a graphical user interface.

28. The card product management system of claim 6, wherein the unique identifier comprises a bank identification number (BIN).

29. The card product management system of claim 6, wherein each card product comprises a card product number,
wherein the card product number comprises a first portion of digits and a second portion of digits,
wherein the first portion of digits comprises a bank identification number (BIN),
wherein the card processors are configured to associate BINs to the card products, and
wherein the agent portal module is configured to allocate card numbers to substantially all of the second portion of digits for each BIN.

30. The card product management system of claim 6, wherein the card product comprises a gift card.

31. The card product management system of claim 6, wherein the card product comprises at least one of a debit card, a health savings account (HSA) card, a flexible spending account (FSA) card, and a reloadable payroll card.

32. A method of managing card product information, comprising the steps of:
a.) interfacing with each of a plurality of card processors; and
b.) selecting one of the plurality of card processors in accordance with a unique identifier associated with a card product to process information associated with the card product.

33. The method of claim 32, wherein the card processors are configured to associate corresponding bank identification numbers (BINS) to the card products, and
wherein the method comprises the step of:
c.) allocating card numbers corresponding to each BIN for the card products.

34. The method of claim 32, wherein each card product comprises a card product number,
wherein the card product number comprises a first portion of digits and a second portion of digits,
wherein the first portion of digits comprises a bank identification number (BIN),
wherein the card processors are configured to associate BINs to the card products, and
wherein the method comprises the step of:
c.) allocating card numbers to substantially all of the second portion of digits for each BIN.
